(19) United States
(12) Patent Application Publication
(10) Pub. No.: US 2005/0101314 A1
(43) Pub. Date: May 12, 2005

(54) Method and system for wireless group communications

(76) Inventor: Uri Levi, Toronto (CA)

Correspondence Address: Ogilvy Renault, Suite 1600, 1981 McGill College Avenue, Montreal, QC, H3A 2Y3, CA

(21) Appl. No.: 10/974,808

(22) Filed: Oct. 28, 2004

Related U.S. Application Data
(60) Provisional application No. 60/518,333, filed on Nov. 10, 2003.

(51) Int. Cl. H04Q 7/20

(52) U.S. Cl. 455/423; 348/14.02; 455/456.3

(57) ABSTRACT

A method for wireless communication between a controller and a group of user devices, each user device having a respective identification number (RFID), comprising: assigning a sequence number (PID) to each user device; transmitting the PID from the controller to each user device; and, in response to a message broadcast from the controller to the group of user devices, receiving a response from each user device in sequence, wherein each response includes the respective PID of the user device, and wherein each user device determines when to transmit its response by comparing its PID with the PID of each transmitted response. The method supports group identification, middle stream devices, multifunction user devices (e.g., remote control, wireless mouse, motion detector), and remote programming of user devices and middle stream devices. Also, a matching method is provided for comparing a sample item to a reference item using the controller and user devices.

This application claims priority from U.S. Provisional Patent Application No. 60/518,333, filed Nov. 10, 2003, and incorporated herein by reference.

### FIELD OF THE INVENTION

This invention relates to the field of wireless communication systems, and more specifically, to wireless communications systems for groups of handheld wireless devices.

### BACKGROUND

Presently, a number of wireless devices and systems are used for various applications including the following: a) cellular telephones for two-way phone conversation which may be high-end and costly; b) wireless mice for use as a single input device to a single display screen; c) universal remote control units that may be web programmable for controlling several devices via infrared signals; d) access control systems using radio frequency identification (“RFID”) RFID tags typically being for wired systems only; e) alarm system activators for remote arming/disarming of automobile or home based alarm systems for car or home alarm; f) personal alert button devices for calling 911 emergency services or for sending other mandown or panic alarms; g) video pattern recognition systems used as input and user interface devices for computers to initiate audiovisual effects; h) dual radio frequency (“RF”) and infrared (“IR”) wireless transmitter systems for personal security in buildings to identify room location of users upon pressing of an emergency button on the transmitter; i) wireless search and location systems using triangulation methods combining with two or more receivers that analyze the direction and strength of the received signals; j) response and voting systems for collecting multiple audience responses wirelessly; and, k) wireless testing and answer response systems for collecting test answers from a group or audience where a guide scrolls through a series of questions on a display screen.

However, due to technology and cost constraints each one of the above applications is typically embodied in a stand-alone system. Consequently, one shortcoming of such wireless systems is their inability to efficiently address multiple applications, such as group interaction and security applications, to accommodate user needs.

A need therefore exists for an improved method and system for providing wireless applications. Accordingly, a solution that addresses, at least in part, the above and other shortcomings is desired.

### SUMMARY

According to one aspect of the invention, there is provided a method for wireless communication between a controller and a group of user devices, each user device having a respective identification number (RFID), comprising: assigning a sequence number (PID) to each user device; transmitting the PID from the controller to each user device; and, in response to a message broadcast from the controller to the group of user devices, receiving a response from each user device in sequence, wherein each response includes the respective PID of the user device, and wherein each user device determines when to transmit its response by comparing its PID with the PID of each transmitted response.

Preferably, the method further includes receiving an acknowledgment from each user device indicating that the user device is available, the acknowledgment including the PID of the user device.

Preferably, each response includes the RFID of the user device.

Preferably, each response is separated by a predetermined period of time.

Preferably, each user device determines when to transmit its response from its PID and the predetermined period of time.

Preferably, the method further includes registering the RFID of each user device with the controller.

Preferably, the method further includes distributing the user devices in an essentially linear arrangement in accordance with the PID of each user device.

Preferably, the method further includes relaying each response between user devices having sequential PIDs to extend wireless communication range.

Preferably, the group of user devices includes a plurality of groups of user devices.

Preferably, the method further includes assigning a sequential group ID (GID) to each of the groups and its respective user devices.

Preferably, the method further includes distributing the groups and their respective user devices in an essentially linear arrangement in accordance with the GID and PID of each group and user device, respectively.

Preferably, the method further includes relaying each response between user devices having sequential GIDs and PIDs, respectively, to extend wireless communication range.

Preferably, each group has a midstream device for communicating directly with the controller.

Preferably, the method further includes relaying each response between user devices having sequential PIDs to the midstream device and then to the controller to extend wireless communication range.

Preferably, the message is an invitation to vote and the response is a vote.

Preferably, the message is a request for alarm status and the response is an alarm.

Preferably, the message is a control command the response is a control execution indication.

Preferably, each user device is a handheld device having one or more user selectable buttons for generating the response.

Preferably, the method further includes authenticating each user device with at least one of the RFID and PID.

Preferably, the message is a counting command and the response is a count.

Preferably, the controller and user devices are located in a classroom.

Preferably, the controller and user devices are located in a vehicle such as a bus.

Preferably, the linear arrangement is used to conduct a search for one or more missing user devices.

Preferably, the linear arrangement is used to conduct a test for radio frequency signal strength for one or more user devices.

Preferably, the linear arrangement and the midstream device are a plurality of linear arrangements and midstream devices, respectively.

Preferably, the handheld device has a manual scroll selector including a thumbsync selector.

Preferably, the selector is for selecting between at least one of wireless modes of operation, communication protocols, and radio frequencies.

Preferably, the handheld device has a motion detector.

Preferably, the handheld device is a remote control.

Preferably, the handheld device is wireless mouse.

Preferably, the method further includes transmitting commands from the controller to program the function of each wireless device.

Preferably, the controller has an interface to a network, including the Internet, and wherein the commands for programming the function of each wireless device are received over the network.

According to another aspect of the invention, there is provided a system for wireless communication with a group of user devices, each user device having a respective identification number (RFID), comprising: a processor coupled to memory and to a wireless network interface and adapted for: assigning a sequence number (PID) to each user device; transmitting the PID from the system to each user device; and, in response to a message broadcast from the system to the group of user devices, receiving a response from each user device in sequence, wherein each response includes the respective PID of the user device, and wherein each user device determines when to transmit its response by comparing its PID with the PID of each transmitted response.

According to another aspect of the invention, there is provided a computer program product having a computer readable medium tangibly embodying computer executable code for directing a controller to communicate wirelessly with a group of user devices, each user device having a respective identification number (RFID), the computer program product comprising: code for assigning a sequence number (PID) to each user device; code for transmitting the PID from the controller to each user device; and, code for, in response to a message broadcast from the controller to the group of user devices, receiving a response from each user device in sequence, wherein each response includes the respective PID of the user device, and wherein each user device determines when to transmit its response by comparing its PID with the PID of each transmitted response.

According to another aspect of the invention, there is provided a method for comparing a sample item to a reference item comprising: selecting parameters for comparing the sample and reference items, the reference item having a predetermined rank score for each of the parameters; selecting a distribution for tabulating votes received for each of the parameters for the sample item; displaying the sample item, reference item, and parameters on a display screen, the display screen coupled to a controller in wireless communication with a group of user devices, each user device having a plurality of selection buttons for generating the votes for each of the parameters for the sample item; receiving the votes at the controller and determining a rank score for each of the parameters for the sample item in accordance with the distribution; and, displaying at least one indication of whether the rank scores for the sample and reference items match.

In accordance with further aspects of the present invention there is provided an apparatus such as a wireless communications system, a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a server system in accordance with an embodiment of the invention;

FIG. 2 includes front and back views illustrating wireless downstream devices in accordance with an embodiment of the invention;

FIG. 3 is a block diagram illustrating an upstream controller in accordance with an embodiment of the invention;

FIG. 4 is a block diagram illustrating a middle stream guide device in accordance with an embodiment of the invention;

FIG. 5 is a table illustrating an example of wireless communication signal codes in accordance with an embodiment of the invention;

FIG. 6 includes a series of block diagrams illustrating a method for wireless line management for interaction in accordance with an embodiment of the invention;

FIG. 7 includes a series of block diagrams illustrating a method for wireless line management for search and control in accordance with an embodiment of the invention;

FIG. 8 is a block diagrams illustrating a method for wireless line joining by upstream/middle stream devices in accordance with an embodiment of the invention;

FIG. 9 is a table illustrating profiles and ranks for a matching method in accordance with an embodiment of the invention;

FIG. 10 includes partial screen captures illustrating a graphical user interface for the matching method in accordance with an embodiment of the invention; and,

FIG. 11 is a block diagram illustrating a server system adapted for implementing an embodiment of the invention.

It will be noted that throughout the appended drawings, like features are identified by like reference numerals.

### DETAILED DESCRIPTION OF THE PREFERRED EMBODIMENTS

The following detailed description of the embodiments of the present invention does not limit the implementation of the invention to any particular computer programming language. The present invention may be implemented in any computer programming language provided that the operating system (“OS”) provides the facilities that may support the requirements of the present invention. A preferred embodiment is implemented in the JAVA™ computer programming language (or other computer programming languages such as C or C++). (JAVA and all JAVA-based trademarks are the trademarks of Sun Microsystems Corporation.) Any limitations presented would be a result of a particular type of operating system or computer programming language and would not be a limitation of the present invention.

The present invention provides a system that is adapted for group related interactions and multimode wireless communications for delivering multiple wireless application to users.

In particular, the present invention provides a system having a web-programmable, multimodal wireless architecture having a rich set of “Secutainment” (i.e., personal security and “edutainment”) capabilities including small-form wearable wireless devices. The present invention includes the following features: a) 4-tier system architecture (i.e., web centre, site controller, mobile guide device, and mobile user device, where the mobile guide device acts as a group and line interaction coordinator); b) a star-shaped wireless handheld device that integrates RFID tags, a multimode two-way RF transceiver, a multimode one-way IR transmitter, motion sensors, audio inputs, audio recognition, button actuators, thumbsync buttons, and visual light controls; c) triple identification including an individual fixed RFID tag, one or more programmable personal/group wireless identification (“ID”) codes, and a personal photo ID on the same device; d) a wireless line method for setting-up interaction lines, control lines, and search line applications, including a line joining method; e) a method for online group interaction by matching two objects (“4*4 Matching”); and, f) support for combined interaction and personal security applications using wireless devices for schools, school buses, coaches, and military applications.

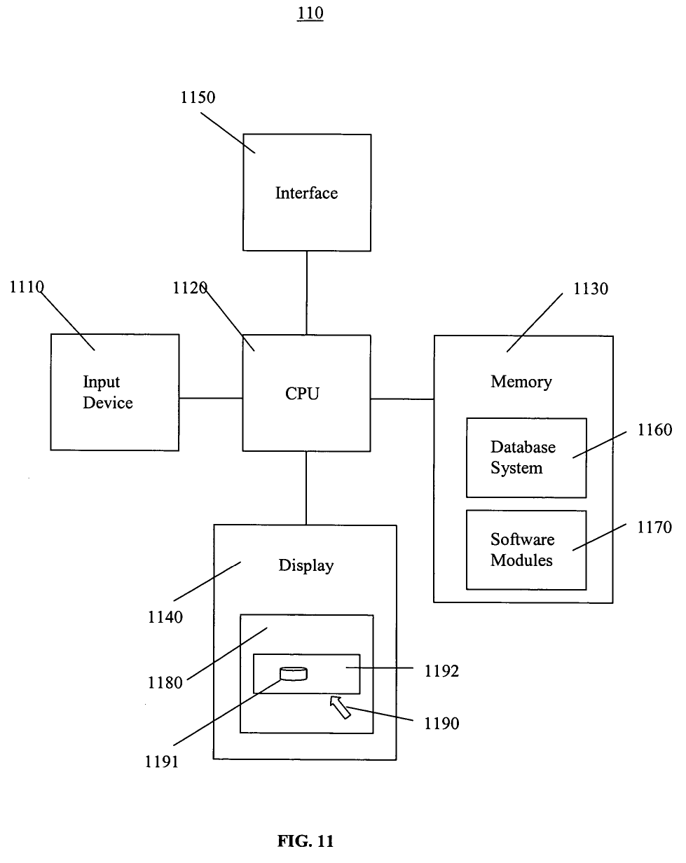

FIG. 11 is a block diagram illustrating a server system 110 adapted for implementing an embodiment of the invention. The server system 110 includes an input device 1110, a central processing unit or CPU 1120, memory 1130, a display 1140, and an interface 1150. The input device 1110 may include a keyboard, mouse, trackball, remote control, or similar device. The CPU 1120 may include dedicated coprocessors and memory devices. The memory 1130 may include RAM, ROM, or disk devices. The display 1140 may include a computer screen, terminal device, or a hardcopy producing output device such as a printer or plotter. And, the interface 1150 may include a network connection including an Internet connection and a wireless transmitter/receiver connection.

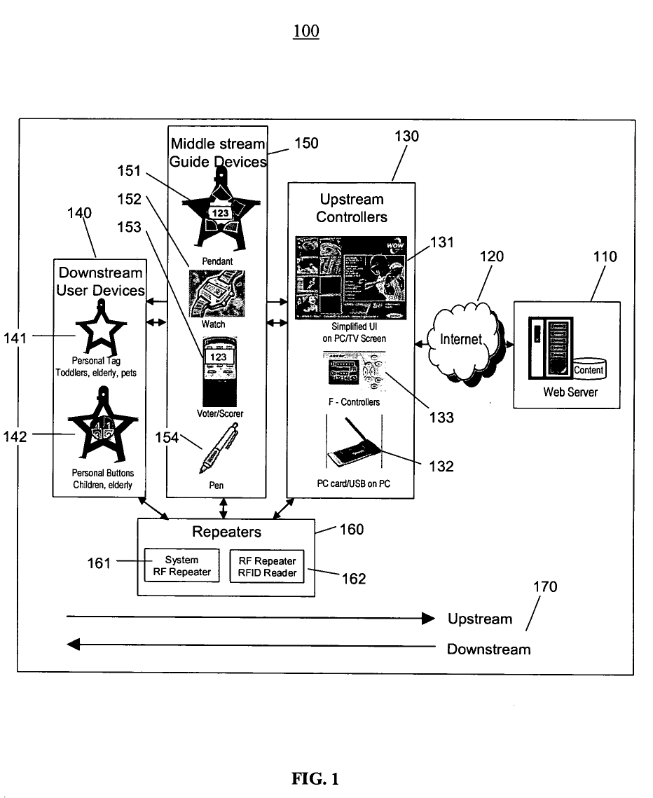

The server system 110 may be a server system or a personal computer (“PC”) system. The CPU 1120 of the system 110 is operatively coupled to memory 1130 which stores an operating system (not shown), such as IBM Corporation's OS/2™, UNIX, etc., for general management of the system 110. The interface 1150 may be used for communicating to external systems and devices 130, 140, 150, 160 through a network 120 (see FIG. 1), such as the Internet or a wireless communications network. Examples of suitable platforms for the server system 110 include iSeries™ servers and ThinkCentre™ personal computers available from IBM Corporation. The system 110 may include application server software (not shown), such as WebLogic® Server available from BEA Systems, Inc., for developing and managing distributed applications.

The server system 110 may include a database system 1160 for storing and accessing programming information. The database system 1160 may include a database management system (“DBMS”) and a database and is stored in the memory 1130 of the server system 110. It will be appreciated that the database system 1160 may be shipped or installed without the database to or by end users. In general, the DBMS is adapted to read a query generated by the server system 110 in response to a request for information submitted by a user typically through a user interface. The DBMS then executes the query against the database and provides a query result to the server system 110 for presentation to the user. It will be appreciated that the database system 1160 may be stored in the memory 1130 of the server system 110 or stored in a distributed server system (see FIG. 1).

Examples of suitable DBMSs include the Oracle® and DB2™ Universal Database Management System products available from Oracle Corporation and IBM Corporation, respectively. The DBMS is a software layer interposed between the actual database (i.e. the data as stored for use by the CPU 1120 of the system 110) and the users of the system. The DBMS is responsible for handling database transactions thus shielding users from the details of any specific computer hardware or database implementation. Using relational techniques, the DBMS stores, manipulates and retrieves data in the form of table-like relations typically defined by a set of columns or attributes of data types and a set of rows (i.e. records or tuples) of data. The standard database query language for dealing with relational databases implemented by most commercial DBMSs is the Structured Query Language (“SQL”).

The server system 110 includes computer executable programmed instructions for directing the system 110 to implement the embodiments of the present invention. The programmed instructions may be embodied in one or more software modules 1170 resident in the memory 1130 of the server system 110. Alternatively, the programmed instructions may be embodied on a computer readable medium (such as a CD disk or floppy disk) which may be used for transporting the programmed instructions to the memory 1130 of the server system 110. Alternatively, the programmed instructions may be embedded in a computer-readable, signal-bearing medium that is uploaded to a network by a vendor or supplier of the programmed instructions, and this signal-bearing medium may be downloaded through the interface 1150 to the server system 110 from the network by end users or potential buyers.

The CPU 1120 of the system 110 is typically coupled to one or more devices 1110 for receiving user commands or queries and for displaying the results of these commands or queries to the user on a display 1140. For example, user queries may be transformed into a combination of SQL commands for producing one or more tables of output data which may be incorporated in one or more display pages for presentation to the user. The CPU 1120 is coupled to memory 1130 for containing programs 1170 and data such as base tables or virtual tables such as views or derived tables. As mentioned, the memory 1130 may include a variety of storage devices including internal memory and external mass storage typically arranged in a hierarchy of storage as understood to those skilled in the art.

A user may interact with the server system 1100 and its software modules 1170 using a graphical user interface (“GUI”) 1180. The GUI 1180 may be web-based and may be used for monitoring, managing, and accessing the server system 110. GUIs are supported by common operating systems and provide a display format which enables a user to choose commands, execute application programs, manage computer files, and perform other functions by selecting pictorial representations known as icons, or items from a menu through use of an input or pointing device such as a mouse 1110. In general, a GUI is used to convey information to and receive commands from users and generally includes a variety of GUI objects or controls, including icons, toolbars, drop-down menus, text, dialog boxes, buttons, and the like. A user typically interacts with a GUI 1180 presented on a display 1140 by using an input or pointing device (e.g., a mouse) 1110 to position a pointer or cursor 1190 over an object 1191 and by “clicking” on the object 1191.

Typically, a GUI based system presents application, system status, and other information to the user in “windows” appearing on the display 1140. A window 1192 is a more or less rectangular area within the display 1140 in which a user may view an application or a document. Such a window 1192 may be open, closed, displayed full screen, reduced to an icon, increased or reduced in size, or moved to different areas of the display 1140. Multiple windows may be displayed simultaneously, such as: windows included within other windows, windows overlapping other windows, or windows tiled within the display area.

FIG. 1 is a block diagram illustrating a wireless communications system 100 in accordance with an embodiment of the invention. The wireless communications system 100 includes the server system or web server 110 which is in communication over a network 120, such as the Internet, with RF repeaters 160, upstream controllers 130, middle stream guide devices 150, and downstream user devices 140.

The upstream controllers 130, middle stream guide devices 150, and downstream user devices 140 may each have a hardware configuration similar to that of the server system 110 albeit on a more compact scale. In particular, the upstream controllers 130, middle stream guide devices 150, and downstream user devices 140 include computer executable programmed instructions for directing them to implement the embodiments of the present invention. The programmed instructions may be embodied in one or more software modules (not shown) resident in the memory (not shown) of these devices. Alternatively, the programmed instructions may be embodied on a computer readable medium (such as a CD disk or floppy disk) which may be used for transporting the programmed instructions to the memory of these devices. Alternatively, the programmed instructions may be embedded in a computer-readable, signal-bearing medium that is uploaded to a network by a vendor or supplier of the programmed instructions, and this signal-bearing medium may be downloaded through an interface (not shown) to these devices from the network by end users or potential buyers.

The web server 110 manages the variety of applications provided to individual users and groups of users that register their devices to the web server and sign-up for the services of their choice. The web server uses methods, known to those of ordinary skill in the art, for user and group data registration, management and reporting. The various applications will be described in below. The Internet 120 is the means of two-way communication between the web server 110 and the upstream controllers 130.

The upstream controllers 130 act as gateways between the web server 110 connection via the Internet 120 and the wireless devices 140 that are positioned downstream 170. The upstream controllers 130 connect to a sound system and a large display screen 131 that may be either a projected image or a large physical display that can display audiovisual content and run interactive sessions in front of a group of users (e.g., an audience). The display screen 131 can be the output of a computer or a television 133.

There are two embodiments of the upstream controller 130. The first is a standard personal computer (“PC”) having the necessary software installed. A wireless interface device such as a PC card or a Universal Serial Bus (USB) device 132 connects to the PC and communicates by two-way RF signals with the wireless devices 140, 150 downstream 170 through the wireless repeater network 160. The upstream controller has RFID reader capability for reading RFID tags from those devices 140, 150 for user authentication. The second embodiment of the upstream controller 130 is a group controller that combines the same display screen capacity, software, Internet connection, two-way RF wireless communication, RFID reading capability as in the PC-based controller. However, this group controller is compact, robust, and is adapted for outdoor mobile environments such as in buses, trains, etc.

The downstream user devices 140 have two embodiments. The first device of this type is the personal tag 141, which is a small wearable device that may be used by children or the elderly. The second device of this type is the buttons tag 142, which is a small wearable device that may includes a number of function buttons which will be described in more detail below.

The middle stream guide devices 150 are positioned between the upstream controllers 130 and the downstream devices 140. The middle stream devices 150 can perform all of the personal user functions of the downstream devices 140, having all the required hardware components, and in addition they include a liquid-crystal display (“LCD”) for providing a higher level of alphanumeric and graphic feedback to the user. The users of these middle stream devices 150 are typically guides for groups such as teachers or coaches or team leaders. These devices 150 enable the guides to perform more advanced group control and line control functions while being mobile in the field. The guide devices 150 may have several embodiments. The first kind of guide device 150 is a star-shaped pendant device 151 having five rounded corners. The second kind of guide device 150 is a watch 152 having a strap. The third kind is a game scorer device 153 having sports game scoring capabilities. And, the fourth kind is a pen based guide device 154 having electronic book display capabilities. Since all these devices 150, 151, 152, 153, 154 share common functionality, a user can exchange his/her device for another form factor guide device and reprogram the new device via the web server 110 and the upstream controller 130 to contain the functions and services from his/her original device. The watch guide device 152, being a representative guide device, will be described more in detail in the following.

The level at which the guide devices 150 operate in the system 100 is advantageous as it enhances the functionality of the downstream devices 140. It allows for an intermediary interaction between downstream 140 and upstream 130 devices thus allowing for the performance of group and line related functions as a mobile network in the field, as will be further described below.

The repeaters 160 include two typically stationary repeaters 161, 162. However, these repeaters may also be mobile. The repeaters 160 function to extend the RF communication range of the user or guide devices 140, 150 in the field to the upstream controllers 130. The first type of repeater 161 includes a microcontroller, memory, firmware for networking and applications, a RF transceiver with multi-channel communication capability, an IR receiver, audiovisual feedback means such as an LED light source, a sound source such as a buzzer or sounder, a power source with rechargeable backup battery, a housing which may be adapted for weather-proof outdoor use, and, in some cases, a solar power cell. The second type of repeater 162 includes, in addition to the components of the first type of repeater 161, an RFID reader that can read the RFID tags of the user and guide devices 140, 150 to authenticate them and perform access control, authentication, and electronic payment functions in conjunction with the upstream controller 130 and web server 110.

The repeaters 160 have self-learning capacity relating to their repeating line topology (as will be described below) and serve as RF access points for remote group or user devices 140, 150. They may serve as a mobile line of repeaters being held by people, mounted on animals, or positioned on moving vehicles, given that they stay in order and in wireless range to keep functioning. Linearly positioned repeater networks can be used for security, control, and interaction applications including the following: traffic-light RF control points for drivers and pedestrians; train-wagon presence and location in stations or in wagon lots; vehicle security, presence, and location in parking lots; and, remote turn-on and turn-off of street light pole lines from a controller or automatically using photocell sensors.

The repeaters 160 are placed in accordance with low RF traffic conditions and they may automatically delay or cancel retransmissions in the case of a high volume of transmissions in the network. The repeaters 160 are positioned in a line sequence configuration and, for simplicity reasons, they do not generally support mesh networking. The repeaters 160 that are sequentially placed in a wireless line, one after the other between the remote transmission areas and the upstream controllers 130, are taught by standard methods of line network creation as are known to those of ordinary skill in the art.

The RF communication directions 170 referred to in the following include the downstream direction from the upstream controllers 130 to the downstream user devices 140 via the middle stream guide devices 150 and the upstream direction is in opposite direction. Note that the Internet connection 120 to the web server 110 is not included in the streaming direction 170 and the repeaters 160 can be placed anywhere between the downstream user devices 140 and middle stream guide devices 150 or between the middle stream guide devices 150 and the upstream controllers 130.

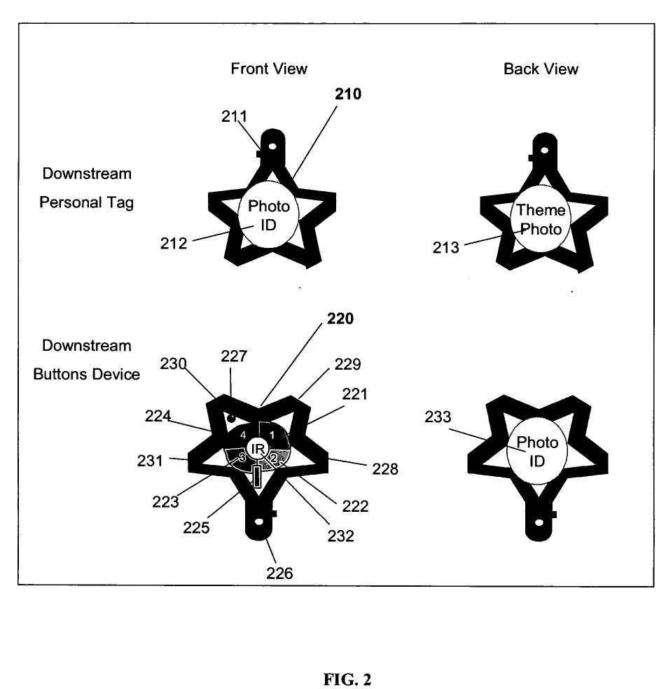

FIG. 2 includes front and back views illustrating wireless downstream devices 140 in accordance with an embodiment of the invention. The personal tag 141, 210 is a generally flat star-shaped device with five rounded corners, one of which has means to attach the tag to a user's clothing using a clip or a ring 211. On both flat sides of the tag there are round areas to affix labels. On one of the flat sides there is a rounded RFID tag 212 that is firmly attached to it. This contains a unique number that identifies the tag and its holder with this number. At least one of these labels is used for photo identification of the device holder. On the second flat side of the tag any other label 213 can be attached related to the individual holding the tag or to the group that the individual is part of. The personal tag 210 includes a microprocessor; non-volatile and volatile memory for data storage; two-way multi-modal RF transceiver that changes its communication frequency and protocol between two or more preset frequencies or protocols; a light-emitting-diode (“LED”) that feedbacks for RF communication with the device; a light source and a sound source either one or both of which can be turned on and off remotely as a result of a command issued from an upstream device. The RFID number on the tag can not only can be read by an RFID reader on an upstream controller but it is also stored within the memory as the unique ID (“UID”) of that device. The storing of this UID is done by the manufacturer during the production of the device. It is sent via RF communication to the device and stored in it so that it cannot be changed later. Any attempt to exchange the external tag to another electronic board will create a mismatch between the UID on the external tag and the UID programmed in the memory of the device in such a way that authentication of the user will fail for most available operations of the device.

The second type of downstream device 140 is the star-shaped device with buttons 142, 220. This device has all the internal capacities of the personal tag 210 and additionally it includes four interaction buttons for user input. The initial four input buttons when pressed represent four values that are sent via wireless communications to be received by upstream controllers 130 or guide devices 150 for further processing. Button 221 is in a red (“R”) color, button 222 is in a yellow (“Y”) color, button 223 is in a green (“G”) color, and button 224 is in a blue (“B”) color. All RYGB buttons are ordered from 1 to 4 clockwise as detailed in FIG. 2. Between button 222 and button 223 there is a fifth thumbsync button 225 that can be pressed and also rolled upward and downward to select between operation modes. The buttons are positioned on the front flat side of the device 220 so that: a) any one of them can be pressed by a single finger; b) any two adjacent buttons can be pressed by a single finger; c) any three adjacent buttons can be pressed by a single finger; d) all four buttons 221, 222, 223, 224 can be pressed by a single finger; e) any two non-adjacent buttons (on the diagonal) can be pressed by two fingers, but pressing them by one finger is also possible as there is enough space between the buttons, which may be somewhat tricky for users having thick fingers. All four button pressing combinations enable the generation and transmission of all the values between 1 and 15. For example: pressing on button 221, will send the value 1 (RYGB=1000); pressing on button 222 only will send the value 2 (RYGB=0100); pressing on button 223 will send the value 4 (RYGB=0010); pressing on button 224 will send the value 8 (RYGB=0001); pressing on thumbsync button 225 only will send the value 0; and, pressing on any button combination, while also pressing on the thumbsync, will send the button combination value ignoring the thumbsync pressing. The LED on the device blinks upon each button pressing.

In addition, the downstream device with buttons 220 includes: a two-axes accelerometer for gesture and motion recognition; an audio microphone, codec and software for recognizing sounds and speech; and, an IR transmitter. The gesture recognition feature is used as for wireless mouse strokes in front of a large display screen while interacting with single-user-single-screen interface or with multi-user-single-screen interface software. The mouse strokes are achieved by accelerating the device from its default holding position. With the key ring held in the palm of the hand, accelerating the device in a direction while pressing a button will move the corresponding cursor on the screen in that direction a distance that is proportionate to the accelerated motion performed with the device. Pressing the blue button 224 in the top-left of the device initiates left mouse button functions and pressing the red button 221 in the top-right of the device initiates right mouse button functions. The thumbsync acts as a regular mouse wheel when pressing it or scrolling up and down. In a multi-user-single-screen set-up each cursor on the large screen of the upstream controller (see below) is associated with one device that can control it with mouse strokes as described above.

The sound and speech recognition feature is used for remote interaction. The device holder talks into the microphone and his/her speech is recognized by the device matching a preset vocabulary on the device and sending the recognized speech corresponding value or code via wireless communication to the upstream controller. This value is recognized by the controller and is used for menu or content interaction on the controller's large screen. The internal vocabulary in the device includes speech recognition for common user interface words such as “Enter”, “Back”, “Left”, “Right”, etc. The microphone is used to digitally transfer via wireless the device holder's voice (i.e., talking, singing, etc.) from the holder's remote location to the upstream controller in order to play it in the sound system connected to the controller.

The IR transmitter has an IR LED that tips out from a corner 229 or 230 of the device 220 and can be programmed by parameters downloaded via wireless communication from the upstream controller. The user can browse the common list of infrared code interfaces for TV, DVD, and audio equipment control by different equipment brands on the upstream controller. This list of remotely controllable devices, from which the user can select, is an updated list received as a web service from the Internet. A similar selection list for remote control is provided as a web service and includes remote control options via RF communications such as garage door openers of various brand manufacturers, car and home alarm systems with secure coding or unsecured coding for remote control. To avoid misuse of such flexible programming of security related system activations and access control coding, a strict and controlled authentication procedure with the programming user is maintained.

Rolling the thumbsync button 225 up and down changes between device operation modes and feedback is provided to the user by either visual blinking of the LED or audible beeps or sounds from the device's sound source, or both. The device 220 can be programmed to function between several wireless (RF or IR) modes of remote controlling operation, where each mode when selected by the thumbsync feedbacks a desired audiovisual feedback signal. For example, a user can select on the web service displayed by the upstream controller the following programmable remote control options: a) as default, a car alarm RF remote control of a certain type with a feedback option of one yellow LED 227 blink; b) a home alarm RF remote control of a certain type with a feedback option of two yellow LED 227 blinks; c) TV volume up/down, channels up/down, infrared control of a certain brand with a feedback option of one red LED 227 blink; d) interaction RF remote control with the upstream controller with a feedback option of two red LED 227 blinks.

Once these options are selected the next step is to program from the upstream controller the user device via RF communication. Once the device is programmed the first mode of “car alarm” as selected above is in effect. When the user scrolls the thumbsync, the device feedbacks the second mode of home alarm control blinking twice in yellow the LED 227. If the user selects that mode by pressing on the thumbsync button, the device will change the mode of operation to “home alarm” mode. Otherwise the user can keep scrolling with the thumbsync until the desired feedback is seen or heard or both on the device until the desired mode of operation is selected. Instead or in addition to the blinking LED feedback a sound feedback can be used so that a single beep or two or more beeps are heard for each operation mode selection. Another option for the desired feedback to scrolling the thumbsync is displayed on a small LCD 232 that is in the center of the area between the four buttons. For example, it shows “IR” for a selected infrared mode, “RF” for a selected RF mode, or a graphic icon of a car when the mode is set to “car alarm” control.

Other options for the downstream button device 220 include: a LED light source or flashlight of one or more colors mounted on the tips of corners 230 or 229 that is programmable and controllable by the four colored buttons; a wire connector on corner 228 that includes wires for device battery charging and 4 general purpose interface outputs (GPIO) that are activated by the four buttons when there is a wired connection between the device 220 and the upstream controller's interface card 132; and, a microphone on corner 231. When the user holds the device by holding the keys attached to corner 226, the corners 229 and 230 face forward so that it is easy to point the IR transmitter and the light source forward for interactions. The microphone on the 231 corner and the wire connector on the 228 corner are also interchangeable.

The RF transceiver antenna on both downstream devices 210 and 220 is printed on a printed circuit board (PCB) within the device.

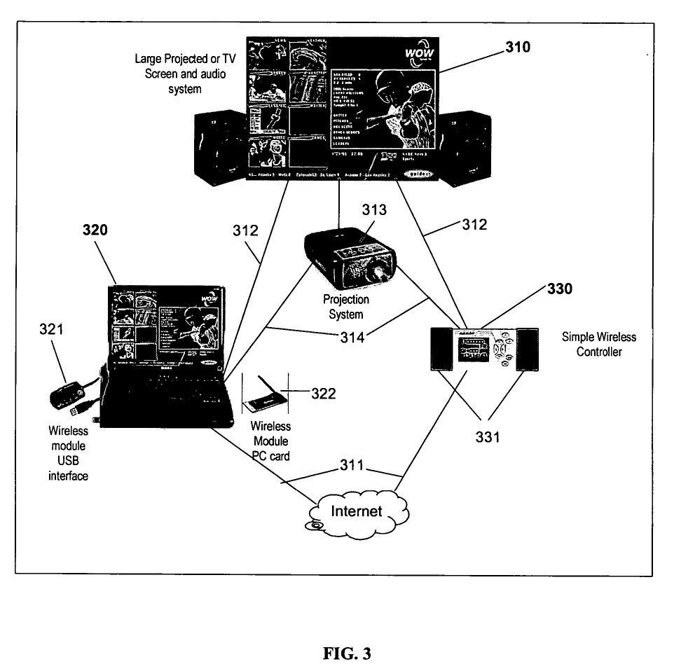

FIG. 3 is a block diagram illustrating an upstream controller 130 in accordance with an embodiment of the invention. The upstream controller 130, 320 is a PC in the form of desktop, laptop, or other portable computer. It connects to the Internet 120 via any standard wired or wireless connection 311 and outputs audiovisual output in front of a group or audience either directly to a large TV via standard audio/video connections 312 or via a standard video/audio connection 314 to a projector 313 to a large screen and a sound system 310. The upstream controller 320 interfaces via USB or PC Card to user and group devices downstream via three or more wireless technologies: a) a multimode RF transceiver that can connect two-way with a single or a number of devices in the audience at once; b) a multimode infrared receiver that can receive multimode IR control signals from a distance of up to 20 yards, from one or more downstream devices at once; or, c) an RFID reader that can read RFID tags one at a time from a proximity of a few inches that are located in downstream user or group devices.

The simple upstream controller 330 is designed as a robust and compact controller for mobile applications. It has the same Internet and large audiovisual screen and audio system output capabilities as in upstream controller 320 described above. The RF transceiver and IR receiver are embedded in this controller. The RFID reader 331 is integrated or attached to the simple controller on either side and there is an option to attach a second RFID reader on the other side of it.

Having the two RFID readers working at once with the system allows it to detect an RFID tagged device either moving from right to left by being read first by the right RFID reader than by the left RFID reader, or moving from left to right by being read first by the left RFID reader than by the right RFID reader. This directional movement detection is used for entry and exit detection from a room door or a vehicle door when the simple controller is installed close to the door and the tag holders that are the passengers of the vehicle or users of the room are in the process of ingress and egress into the room or vehicle through the door. Usually, standard access control systems that use RFID technology have a single reader and when a user holding an RFID tag is read and recognized by the controller, the controller allows the opening of the door and registers that user as a entered user. When the user exits that door or another door, the system registers the exiting user and registers the exit time. These systems allow access only to those who are known to the system and are authorized users. The dual RFID reader method as described with respect to the simple upstream controller 331 allows entry of users who were not previously known to the system as authorized users, however once their entry direction and identity are detected by the simple controller, they are ready to interact with the same controller in various interaction sessions as will be described below. They can also exit from that room or vehicle when they are detected by the RFID readers in the reverse order from that when then they entered.

When the simple controller is placed, for example, at the front and only entry into a bus, any passenger that holds an RFID tag can enter the bus and become registered, then when the user is seated he or she can interact with the simple controller in entertainment, voting or remote controlling applications. At the end of the journey the passenger exits the bus, is registered as such, and the identity is erased from the users that can interact with that simple controller.

Consider the following cases: a) if the entering passenger to a bus transfers his user device through the window to someone else that tries to enter the bus for the first time, but for a second time for the user device and tag, the system alarms so that this re-entry can be avoided. As a result, this method can be used for travel ticket verification; b) the simple controller can allow anybody into the vehicle or room except users whose tag ID are blacklisted, that is, users not permitted to enter the vehicle; and, c) when a passenger or user who exited the vehicle or the room tries to interact via RF communication using the push buttons from outside while an interaction session is being conducted inside the vehicle or the room, the simple controller will discard these signals. The purpose of this is to avoid outside disturbances to interaction sessions that are going on inside and also assuming that the outside passenger cannot properly see the input of the interaction sessions inside the vehicle or the room and therefore he/she is in a worse position than those inside the vehicle or room with respect to interactions.

The two RFID readers 331 that connect to the simple controller 330 can be placed at a further distance to allow a firmer confirmation for the intended ingress or egress action. A user tag that is detected by only one RFID reader and not yet by the second RFID reader is considered by the controller having an “in-process” status, having not completed the ingress or egress action. In this situation the user can do one of two things within a preset period of time: a) either complete the ingress or egress action by being detected by the second RFID reader; or, b) go back through the same RFID reader that read him before and thus cancelling the action altogether. If the user does not perform one of these two actions he is considered as “stuck-in-the-middle” which is an illegal situation requiring further action by the system.

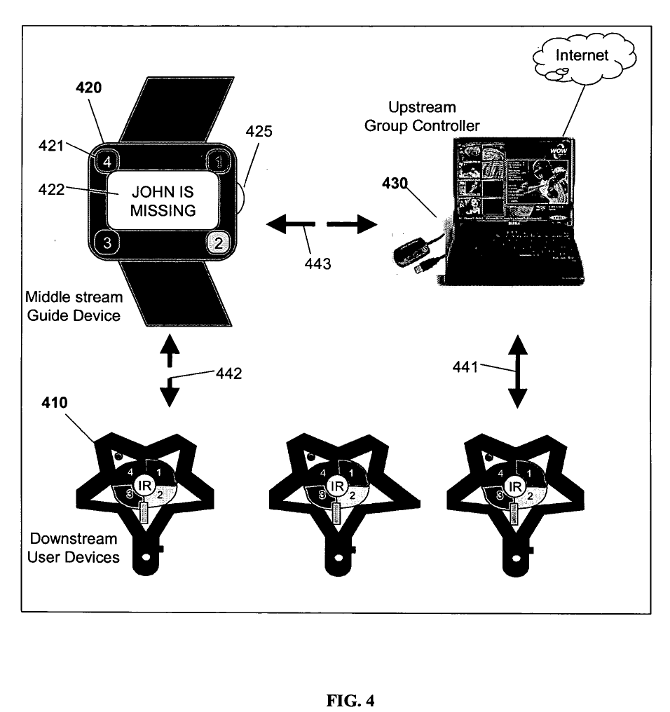

FIG. 4 is a block diagram illustrating a middle stream guide device 150 in accordance with an embodiment of the invention. A middle stream guide device 152, 420 in a watch form factor is shown in FIG. 4. It has all the functionality of a user device 142, 220. It has five buttons of which four buttons 421 are the red, yellow, green, and blue buttons positioned around the center of the watch and a thumbsync button 425 is positioned on the right edge of the watch enabling menu scrolling and menu items selection. In the center of the device there is a large LCD panel 422 that can display two or more lines of multiple characters and graphics information to the user including time and date. The RFID tag is placed in the back plate of the device and the infrared LED, the microphone, and the wire connector that were described above for the downstream user devices 220 are also placed on the edges of the watch. The middle stream guide device 420 optionally includes: an outdoor location and navigation means such as a temperature sensor for out-of-range temperature alert; a digital compass; a Geographic Positioning System (GPS) receiver; and, a common or multi-channel cellular data modem. In other guide devices such as the pendant 151,the scorer 153, and the pen 154, all these features are also included to perform the functions of the watch 420 that will be described below.

The guide devices 420 are of a hybrid nature. In front of an upstream group controller such as one that manages an entertainment interaction the group device communicates via bi-directional RF 443, via infrared transmitter and can participate in the interaction session as any other downstream user device in the room communicates 441. In front of downstream user devices the group device can communicate via bi-directional RF 442 and perform part of the functions of an upper stream group controller. Among these functions are interaction session start, resume and stop; access control allowing the user devices to check-in and out of the facility by exchanging RF signals with the guide devices as will be described below; creation, activation and releasing wireless lines of user devices as will be described below.

The system controls through its various components the execution of several applications that are either served remotely by a web service site or used locally as a utility and information tools by the user.

The system supports multiple wireless communication techniques. The system addresses several wireless RF communications and signal transfer challenges in order to perform efficiently. The challenges are partially derived from the system's features and partially derived from regulatory and market driven restrictions and those are: a) concurrent interaction with many devices at the same time may cause jamming; b) “heavy” interaction methods such as gesture or voice or video recognition that may consume broad band communication and cause jamming; c) the requirement of sending at times short messages and at times long messages; d) the requirement to free the wireless spectrum use in case of emergency or restricted interaction; e) the requirement of selectively and real-time responding to certain signals from certain users in a signal crowded environment; f) the requirement to change the wireless range from higher-speed/shorter range for data transfer and interaction applications to lower-speed/longer range for security applications; and, g) different regulations for open frequency usage in America, Europe and the rest of the world. Several techniques are used in the system to address the above challenges.

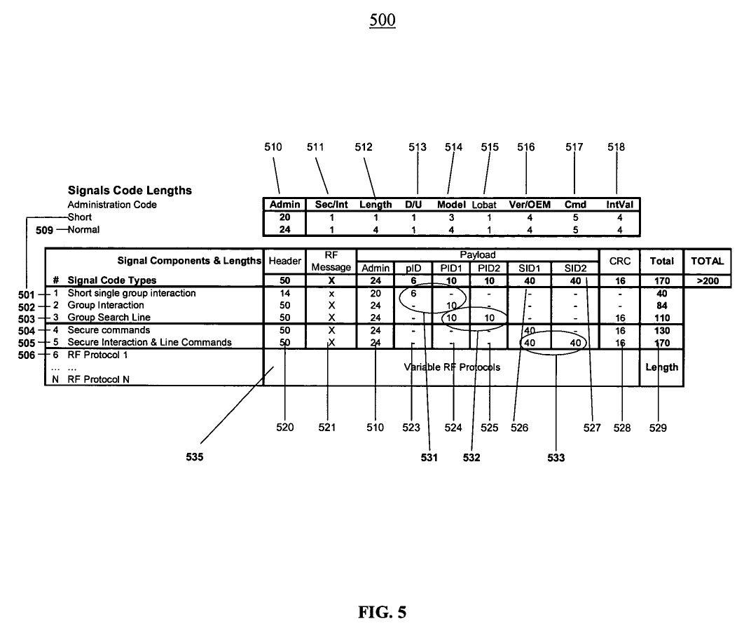

FIG. 5 is a table 500 illustrating an example of wireless communication signal codes in accordance with an embodiment of the invention. Along with the title of each communication technique 501, 502, 503, 504, 505, 506, 509 FIG. 5 shows exemplary wireless signal codes for these techniques. It will be understood by those of ordinary skill in the art that alternate signal codes may also be used.

A wireless RF signal includes a stream of bits that include a preamble or a header 520 that is of a length defined by the device manufacturer. The fact that this system's devices have to be programmable and compatible to different manufacturers' devices the code length and the header bits that vary according to the different protocols have to be preset in advance on both transmitting and receiving devices.

A second set of bits 521 are related to the RF message envelope required by the RF transceiver chip manufacturer. The third set of bits includes the payload that includes Admin bits 510 and ID bits. Then the optional standard cyclic redundancy check (“CRC”) bits 528 are added to ensure proper sending and receiving of the signals. CRC bits are not included in the short single group interaction 501 case hence reducing its coding size to a minimum.

The Admin bits 510 include a number of sets which will be described in the following.

A security and interaction command discriminator 511 is included where 1 is for security commands and 0 is for interaction, or vice versa but consistent one way or the other throughout the whole system. The security commands indication, as opposed to the interaction indication, provides the system and the devices the opportunity to encode and decode the messages based on higher level of security and reliability of reception. The secured signals typically include the unique IDs of the source or destination or both and depending on the command context that they take part in. Secured signals are also typically accompanied with CRC error detection and correction bit series as part of the signal code for higher reliability of signal reception. This is a unique indication of commands used in wireless communication systems.

A length of message indicator 512 is also included. While the header 520 allows each receiving party to synchronize on the reception of the signal the length of the payload may differ from one message to another. In this system the main difference in signal lengths are due to number of IDs attached to the command and whether these IDs are secured including the long RFID code or not secured including the short programmable IDs. The length of the signal also depends on the command type if those include any or one or two IDs following the command. The length indicator equals 0 if it is short message of the line structure 501 or starts with 1 otherwise having three more bits to specify which type of messages of lines 502 to 506 is dealt in the current signal. The change of the signal lengths is initiated by the system controller to the downstream devices or by guide devices to peer guide devices or to downstream devices in the group.

A downstream or upstream indication 513 is included for the RF signals in the air. The downstream indication can be 1 and the upstream indication can be 0 or vice versa and kept consistent throughout all transmissions in the system. This indication is an efficient means to discard many of the ongoing traffic in the RF network that is indicated by a non-expected downstream/upstream indicator. When an upstream controller sends a message to downstream devices it sets this indicator to downstream so that all downstream devices can interpret the command as such sent from the upstream controller. When a downstream device sends a message to middle stream guide device or upstream controller this indication is set to upstream so that all other downstream devices can ignore automatically this message since it was not destined to them. Checking this indication by receiving devices is an immediate way of discarding a large part of the communications taking place in that area. The middle stream device when addressing downstream devices would turn this indication to downstream and when addressing the upstream controller would turn this indication to upstream.

Exceptions to this scheme are: i) when a system controller transmits a signal to another system controller for data exchange the indication is set as upstream; and, ii) when a simple user device takes part in “line” commands such as “search line” and “interaction line” as described below, and sends an RF signals to his/her peer simple device user the indication is set to downstream.

Another important indication to decode and interpret commands by devices are the model bits 514. A model could be a device type and it is used to decode and interpret properly commands that were originated from various models. For example a certain model number would be possible to upgrade from current to new upgrade version and other models would not be. Another example is that certain services could be enabled from the web only for certain models and not for other models of devices that are already in the field. This indication enables a flexible selectivity of devices in various operational and programming purposes.

The low battery indication 515 is set on (or off) when the battery starts weakening below a preset threshold. The indication accompanies each signal transmitted from that device to indicate upstream devices and the user to recharge or replace the battery but does not interfere with the regular functionality of the device.

The version and OEM (original equipment manufacturer) indication 516 is meant to identify a certain version for system that was designed for internal purpose or to satisfy a certain customer called here an OEM. This set of bits allows to OEM the system devices to other manufacturers' market distribution channels by adjusting the functionality specifically to their requirements or by supporting their system protocols. The update of software release could be limited not for certain device model numbers 514 but also to certain Version/OEM device identifier 516. This notation of the product is used for adding and updating services enabling depending on the capacities of the product. Also in certain command contexts the product type adds different meaning to the functionality of certain commands and their execution.

The command selector bits 517 include in this example 5 bits, but more or less bits could also be used. This allows 32 options for various command types and together with the 511, 514, and 516 indications could provide numerous more combinations for command coding and functionality by the system. For example, command number 9 with a security indication can be for requesting the destined device to identify itself (e.g., a “who-are-you?” command) whereas the same command with an interaction indication can be for requesting the designated device only to start talking one-way with the controller.

The internal value bit set 518 is meant to provide a parametric add-on to the command and it has 4 bits in this example enabling 16 different options. For example, the reply to a VOTE command from the upstream controller could be any combination of buttons on the downstream device, where if the user on the downstream device pressed on the Red button the value that is returned is 1 (i.e., 1000 or 0001 depending on the implementation), if the user pressed on the Red and Blue buttons the value that is returned is 9 (1001). Pressing on the thumbsync button only will return 0 (0000) value, pressing on it while pressing on other buttons as well will send the value of all buttons discarding the thumbsync button.

The difference between the short message's 501 admin. code and the normal message's 509 admin. code is that some parameters' bit lengths were reduced to the utmost minimum in for the short message 501 in order to optimize transmission and reception times and capacity when using short messages.

The ID bits in the wireless code's payload can be one of six types as follows:
For a sort single group interaction 501, the ID is a personal ID (pID) 531 of 6 bits representing user IDs from 0 to 31 in a single group environment;
For a regular group interaction 502, a personal ID (PID) 531 of 10 bits representing 4 bits for group ID (GID) from 0 to 15 and 6 bits for pID as in the previous set of bits;
For a group search line 503, two PIDs of 10 bits each 532 and as described in the previous set of bits, one representing the ID that is missing and is searched for, and the second is the ID that has originated or destined by the command and depending on the command type;
For a secure commands line 504, a secure ID (SID) 526 of 40 (or 64 or other number of bits used on RFID tags) bits representing the RFID tag number that was taught and transferred to the memory of the device by the upstream controller with the RFID reader that read and programmed the device during the registration routine; and,
For secure interaction and line commands 505, two SIDs 533 of 40 bits each as described in the previous set of bits. The first SID in secure interaction sessions serves the command originating upstream controller SID so that only the group members having registered it in their memory as their group controller can interact with it, all others will not respond to the commands originated by it. The second SID in secure interaction sessions includes the destination SID of the devices that have to reply to that command. A user device that its SID is identical to this second SID responds to the command and all others stay mute. In secure search line commands one of the two SID is used to define the missing and the searched for SID of that device and the second SID is the originating or the destined SID of the device depending on the direction upstream or downstream in the network and this will be further described below;
The various RF protocols 506, that the device can learn and communicate with, differ by their RF frequency, modulation, code length, and content. If those other manufacturers' protocols could be used and programmed by the system devices and a specific device is in the communication mode to operate in that protocol meaning that the signal code would be encoded by the transmitter device and decoded by the receiver device that take part in that communication.

The total column 529 represents the total bits per each signal code type from lines 501 to 506.

Advantages of the above code components include: the security and interaction command discriminator 511; varying lengths of signals to accommodate multimode RF communications 512; variability to accommodate different manufacturers' RF protocols 506; and, dual mode identification using programmable short ID including personal and group IDs, or using a fixed long personal ID that is the pre-programmed unique RFID tag number 532, 533.

The system supports signal receipt confirmation and retries. In certain secure commands or in commands destined to individual users a signal confirmation receipt is necessary to complete the command. If such a confirmation was not received by the expecting device, it sends a retry message to verify a proper receipt. There might be several reasons for the destined device not to reply: a) RF jamming; b) out of range; c) busy in signalling or data transfer; d) being in back-off mode; and, e) device turned-off or dead.

The retries schedule from the originating device can have a flexible time scheme depending on the command context and security mode as follows: a) fixed timely retries for a certain time; b) intermittent schedule such as k retries with x seconds interval between every two consecutive retries, then y seconds recess and again for z1 cycles or z2 minutes; c) accelerating scheme—retries every increasing n, 2n, 3n seconds or decreasing m*n, (m−1)*n, (m−2)*n seconds for z1 cycles or z2 minutes; and, d) any fixed or variable or random intervals.

The programmability of the retry method as detailed above is an advantageous feature of the system.

The system supports multimode RF protocols. The system devices include RF transceiver components that can dynamically change the RF protocol, the frequency, the modulation type, the signal strength as a response to an “RF switch” command that is received from an authorized upstream device. Thus the device can learn several RF modes of operation so that it sends in each mode a different RF protocol as a result of its activating means or as a response to other devices in the system.

The RF-switch command can be initiated in several ways as follows: a) by an authorized upstream device destined to downstream devices selecting the RF protocol to be current; b) the guide device user changes manually his/her own RF protocol on the device when he/she is checked out of any system controller's control area; c) the system controller when detecting an RFID entry event of a device can send a switching command to the respective RF protocol that is in effect in that organization; d) automatic RF protocol switch by pressing on different buttons on a group guide device following a teaching process of RF protocols per each pressed button, so that for example one button can open a garage door, others can lock/unlock the car alarm of two RF system manufacturers; and, e) inactivity timeout—when a user device stops communicating with a guide device or a controller for a preset time duration, meaning it does not receive any commands or supervision verification signals and following a “request for reply” signal to upstream devices is not replied, it assumes itself “lost”. In order to facilitate its search and finding by other guide devices, the user device switches automatically to a search mode, which is an RF protocol, frequency and power strength mode in which it can function in an extended range and would be easier to find it.

The system works in standard narrow-band/multi-channel protocols in order to allow several devices to send signals in the same time without interrupting each other. In this case the receiving system gateway or controller sends a command to work in this multi-channel mode where each device sets up to its own channel and replies or communicates in this channel while the system upstream controller receives all the signals concurrently from the RF band and processes them without interruption.

An RF-protocol programming engine on the upstream controller can select new RF protocols and program them onto the downstream devices. This includes the mapping the RF protocol parameters such as frequency, modulation, code length and structure, simulating and testing those on the upstream controller software and downloading the resulting parameters and programs using XML or another data transfer format to the downstream devices for activation by their push buttons and thumbsync.

The programmability of the multimode RF protocols as detailed above are an advantageous feature of the system.

The system supports time-scattering. Following an emergency event, a broadcast message, or a start of an interaction event all the users tend to activate within a short time their means of interaction. In order to avoid RF spectrum jamming the devices use an automatic time-scattering mechanism of signal transmission following the device's input activation by the user. This method is based on one or more of the following techniques within a certain time duration limit: a) a random generated delay by each device; b) a delay based on manipulation on device's unique secure ID (SID); and, c) a delay based on manipulation on device's programmable ID (PID).

Although this method enables better signal dispersion over time and collection in a high traffic signaling environment, it does not guarantee a first-activated-first-received effect. When the timely dispersion of the signals depends on the device's programmable ID, this embodiment gives an advantage to devices with lower IDs to send messages earlier than other devices, although the reverse may also be implemented.

The system supports battery saving features. Since all the mobile devices in the system are battery powered and the fixed devices have backup batteries, there are several standard techniques to save energy on the devices. When the battery power decreases below an acceptable threshold, a dedicated “low battery” bit 515, which is part of the signal code is set on for every future RF transmission until the battery is replaced or recharged above the acceptable power threshold. The techniques used in these devices include: a) timeout—the devices that do not interact from last operation for a preset period of time turn the circuit to a low-power mode or sleep mode that saves battery power; b) no motion—in cases that the device has not been moved, where motion can be detected by a tilt-switch or an accelerometer for a preset period of time the device switches to a low-power mode or sleep mode that saves battery power; and, c) extreme temperature—in devices with digital thermometers such in middle stream devices, when the device becomes exposed to extreme temperature beyond the specified operating temperature this may harm the battery or other components in the device, hence when the device detects the exceeding temperature by the sensor it turns the circuit to sleep mode or shuts it off.

The system supports group commands and applications. In this regard, the system supports group IDs as follows. Each group of users has a local programmable ID of its upstream system controller that is sent to all the devices that belong to the group. The group guides, such as teachers or coaches, control the security and interaction applications either locally using the upstream controller in the room or when they are mobile using their middle stream guide devices. For example the group guide can collect check-in and check-out signals from all member devices by broadcasting an appropriate command to them, or it can start an interaction session on the system controller and advance from one session to the next, where in each session the group members can interact with the content on the system controller. The interaction can be presenting a question on the screen of the controller, collect all the wireless votes replied from the user devices, showing their total or other statistics on the screen and move on to display the next session reopening a new voting collection and calculation.

Another interaction is allowing a group of users to start a game on the screen such as chess played by two users or bridge played by four users and alike games, where each user controls his or her cursor or cards or other input means by using his/her device as per gesture strokes that move the mouse cursor on the screen and selecting objects or menu items by pressing on the five interaction buttons on the device corresponding by shape or by color or by rules to the user interface items on the screen.

The grouping function allows interacting among the group members and guides only and discarding all other group members and guides signals that have a different group ID from the one they own.

Next, the system supports addressing individual IDs versus broadcasting to groups as follows. Upstream system controllers and middle stream guide devices can send a signal to a specific user or guide device by including its unique secure ID (SID) or local programmable personal (PID) within the group as part of the signal. The programmable short PID includes the group ID (GID) and the personal ID within that group (pID). Thus instead of communicating with SIDs of 40 to 64 bits length, PIDs are of 8 to 10 bits length leading to reduced total signal lengths and improved performance. The addressed device need only match the ID in the message to its own ID and react to that command while all the other users discard it. A broadcast signal has in its ID all zeros (or all ones depending on the implementation as long as it is consistent throughout the system) and thus is addressed by all the users in the group or on site depending on the group ID (GID). If a GID is other than all zeros, all the group's members carrying that GID respond to it; if the group ID is all zeros and user ID's are all zeros, it is a broadcast command to all groups and members that respond to it; if the GID is all zeros and the user ID (UID) is specific (other than all zeros) then the signal will be replied by all groups' members that carry exactly that specific UID. A broadcast command destined to a group is executed by all the members of that group and is discarded by all other devices.

The system also supports backing-off RF transmissions as follows. There are cases where upstream controllers can send either explicit commands or implicitly other commands that request from destined devices to “back-off” their RF transmission until a “back-off release” command is issued. A “back-off release” function is performed by the destined devices in one of the following cases: a) received explicitly in a proceeding command; b) implicitly as part of a proceeding command; and, c) by auto-release timeout that becomes effective on the device after a preset timeout, in order not to disable the device for too long.

If “back-off” is required by an authorized upstream device it should initiate a recurring back-off command every time period that is lesser than the auto-release timeout period on the device. The back-off function releases the RF spectrum from undesired transmissions allowing only those authorized users to act with minimum disturbance or potential of being jammed. Examples for the use of back-off commands are: a) when searching a missing user device the guide wants to cease all other interaction sessions that may be heavily using the RF spectrum; b) in interaction mode of “First wins, Accumulated results” as described further below, the guide or the system controller send a back-off command to all the user devices except the one that was received first and in order to privilege him solely to further interact with the system controller; c) in line commands such as “search line” and “interaction line”, and where there are a large number of participants allowing concurrent usage of the RF spectrum may result in a high retry rate and spectrum blocking effect. In order to manage the crowd a wireless line is created, where an interaction output is not released as an RF signal by a device until its turn arrives in the line.

The system supports a dual wireless RFID and RF authentication method as follows. The dual wireless RFID and RF authentication method has the purposes of security and efficiency in the system. If wireless devices could be addressed by their minimal address code length, the overall transmission becomes more efficient and it enables to address more users in a shorter time. Thus sending a message to an individual student from a thirty students class of three classes will require an address length of 2 bits for the group ID (out of 3 classes) and 5 bits for the individual ID (out of 30), total of 7 bits.

The fixed unique individual identification using RFID tags on the devices provides a more secure means that the transmitted message will reach the destined apparatus, however those IDs are longer usually up to 64 bits length.

The system includes the addressing of both methods. Once a device is registered to the web server via the upstream controller its fixed secure RFID code (which is the SID) is read and registered in the web server and in the upstream controller. This SID was also registered within the memory of the device at the manufacturing stage so that any initial addressing and programming by the upstream controller could be done by addressing this SID. The upstream controller with the RFID reader first authenticates by matching the read RFID tag number to the internally registered SID that is transferred via wireless or via the wire connector from the device to the upstream controller. Once the match between the two was found, the upstream controller can program the device its new PID including the group ID it belongs to and the personal ID within that group. This authentication and PID programming is used for shorter and more efficient signaling with these devices. If an RFID tag was attempted to be replaced its new RFID will not match to the SID that was received from the device thus leading to cease of services provision to that device.

The system supports a dual method for entry and exit control as follows. RFID is widely used for access control and time and attendance. RFID tag registration and access control activation is enabled only by the tags that are in proximity to the RFID reader. This method is quite secure and handles usually a single user at a time. The two main disadvantages of this method are: a) not being able to register and access control from a distance; and b) not being able to register events from a large group of users all at once. The dual access control and time and attendance methods of the present invention which are based on either RFID or RF technologies at a certain time overcome these disadvantages. The multimode RF communication enables to register an entry/exit event or open remotely doors even when the user is not in proximity to the registering apparatus. Registering entry/exit events from a large group within a short time is enabled following the creation of a virtual line of the users in the group as will be described below.

Another method for access control that replaces the proximity RFID reading of the tag is a remote RF communication of a user ID code following that user gesture detection and matching to the pre-registered access control gesture pattern. This method of remote access control includes the following steps:
Step 1: User Setup. The user holding the downstream or middle stream device enters a registration step in the upstream controller running a special registration session on the web service in which the user fills his/her details, and introduces the RFID tag identity to the RFID reader to register it onto the web server.
Step 2: User Gesture Teaching on the upstream controller. The user enters into a teach mode of the gesture to be recognized for his/her remote authentication on the upstream controller, where the user performs a motion with the device that identifies him/her. This motion is parameterized by the accelerometer on the device as the user's signature to provide two axes acceleration profile as a function of time. The profile consists of a series of X and Y axes acceleration values within fixed intervals of time (e.g. every 0.1 of a second). This signature is entered as the user's authentication gesture into the upstream controller such that each gesture that is performed as per access attempt is parameterized and sent together with the user unique ID via RF communication to the upstream controller in order to match the recorded signature. Access is granted if there is a match between the performed gesture and the recorded signature of that user ID on the upstream controller. During the gesture registration process on the web server the user is requested also to enter a hint that would remind him/her the gesture signature's characteristics. For example if the user records his/her handwriting signature also as a gesture signature (s)he can enter in the hint field “My handwriting signature”.
Step 3: User Authentication. On a daily basis the user when entering or exiting the facility (s)he can authenticate using the proximity RFID tag reading on the upstream controller or (s)he can perform the gesture as registered in step 2 for authentication. The gesture is then parameterized and sent together with the user ID to the upstream controller for authentication. If the gesture signature matches the recorded one access is granted, otherwise access is avoided. Registration of entry, exit times and other features related to access control and time and attendance can be fulfilled as in known systems.

Instead of authenticating the gesture with the recorded one on the upstream controller in lower security applications there can be a self authentication method in which the user authenticates the gesture by matching it to a pre-recorded or a default gesture parameters on the own user device. For example if performing a gesture of waving the hand left and right while holding the device as in ‘Hello’ and ‘Goodbye’ gestures, the device will detect this gesture as an entry or exit request that together with the device's ID will be sent out via RF communication. The waiving is detected by a position change sensor in the device (tilt-switch or accelerometer). Now there are two ways of feedback to say to the device that the request has been processed.

On an upstream controller device a beep or a display will show that the request has been received and it would be processed as an entry request if this is the first request that day or following a previous exit request. The request will be processed as an exit request if the previous request that day was an entry request.

On a middle stream guide device the guide holding the device will receive the request and see on the display of the device the request for entry/exit of his/her group members only. The events of entry and exit are accepted by the group's guide device in certain conditions, for example: a) by time—entries and exists are expected at certain hours that were downloaded from the system controller or preset on the group guide's device; b) the guide sets the “listen to entry” or “listen to exit events prior to asking the group members to wave; and, c) the first waving time in a certain day is registered as entry time and all the next waving times overwrite the exit time so that the exit time is always updated. The guide acknowledges the request by sending an RF acknowledgement command by waving his/her hand holding or wearing the device left and right as in “Hello” gesture. The command following this waving will be sent via RF communication destined to the ID of the requesting device for entry/exit using the PID—the programmable short ID.

At any time or at the end of the day the group guides approach to the group's controller to download via wireless communication all the time stamps and the IDs of their group members' entries and exits into the database of the system for report generation. Any multiple entries of entry/exit requests that were received with the same (or similar) timestamp both by the upstream controller and one or more guide devices will be unified into a single record on the report.

An advantageous feature in the system's devices is the dual authentication capacity for access control, the first one being in proximity using the conventional RFID tag reading by a static reader such as the one in the upstream controller, and the second being remote using gesture detection and parameterization on the user device and either authenticated on the same device and sent out via RF to the upstream controller or sent first to the upstream controller via RF communication and later authenticated on the upstream controller.

The system supports RFID for fixed security and synchronization functions. This is a common application where the user has a user device with an RFID tag and when passing by an RFID reader that recognizes the personal tag, permits access by opening a gate or registers the event as an entry or exit. The RFID tag's ID is unique and assures a one-to-one secure authentication of the tag by the RFID reader. This known method permits also electronic authentication of a user entering a web site using an RFID reader interface that identifies the user by his/her unique tag ID.

Every user or guide that belongs to an upstream controller's site, such as a classroom or a test room starts by registering his/her device using the RFID tag that is part of the wireless device.

Fixed access control and time and attendance functions are performed when the user approaches the registered device to the RFID reader that identifies its tag and enables its registration at the system controller.

When a guide device accesses the system controller an information synchronization process can start working. This is in case there is newly stored information on either of the system controller and the guide device after a last synchronization process. Synchronization of time and date or software updates from the upstream controller to the downstream and middle stream devices can also be done at the entry/exit events when using RFID reading.

The system supports the assigning of a new group to user devices as follows. A group ID can be assigned to a user device by the upstream controller that manages the group data, such as in a classroom or an auditorium. In this case the upstream controller addresses the learning device by its unique RFID to assign it a programmable group ID.

Another way of assigning a new programmable ID including the group ID and the personal ID is done by a programming device being either by the middle stream guide device or the upstream controller. The programming device broadcasts a command to switch to a different RF channel or to a reduced transmission power RF protocol. After all the devices around switch to this new RF mode the programming device switches as well to this new RF mode and broadcasts the command “Who are you?” to all devices in range. The user devices reply with their programmable IDs to the programming device. The programming device analyzes the replying devices' IDs, if they all belong to the same group ID the programming device can interact with them by using the same group ID with the existing registered personal IDs. If the replying devices belong to more than one group the programming device assigns a new group ID and consecutive personal IDs in that new group and teaches the devices in range the new IDs. The teaching is done by sending the “Assign ID” command destined to each device to its original ID, attaching the new programmable ID to be assigned to that device. The process continues until all the devices that communicate by the new wireless protocol are taught of their new programmable IDs. Now, interaction sessions can take place between the programming device and the user devices within the new wireless protocol by addressing to their new programmable IDs.

A programming device, being either an upstream controller or a middle stream guide device, can assign several group IDs to a device and enable it to take part in several groups and thus increasing the probability of receiving the transmissions from that device in an RF crowded environment.

The system supports a simple user interface (SUI) as follows. A mouse as an input means in every computer system drives the cursor on the single screen of the computer and usually when several users play and interact together in a single arena they use each a networked terminal to a central server. The simple user interface (SUI) method of the present invention allows multiple user input, navigation and mouse interaction, each user having his/her own cursor driven by his/her apparatus. Controlling more than one mouse at a time in front of a single screen is currently not part of commonly used operating systems and requires special software. Each cursor is visually identified to the audience by its associated apparatus number or its special drawing or bitmap related to it. A benefit of this method is for example in a school environment, where all the students of a class can interact with a SUI compliant edutainment content using their apparatuses without waiting in line to access the single computing and input resource in the class. Also one or more individual or group interactive games are enabled on a single screen.

Although controlling multiple mice by software running on a single screen is known in the art, the advantage of the present system is the dual ID registration and association of the user device to the specific cursor on the screen. Thus the short programmable PID including the group ID and the personal ID within the group can serve to identify and associate the user to his/her cursor movement on the screen when interacting in a small group; or the long unique secure ID (SID) can serve to identify and associate the user to his/her cursor movement on the screen when interacting in a large crowd setup.

The system supports line commands as follows. Wireless lines are a flexible means to communicate signals in wireless networks and they serve two main purposes. The first purpose of the wireless line is to extend the range of the transmitted signals in case the line consists of users that physically stand or move as a consecutive line distanced apart from each other by a distance less than the maximum range that their wireless devices can receive and transmit signals. The second purpose is to administrate the order by which a large audience interact with the system controller or with a guide device during an interaction session without causing a spectrum saturation effect due to repetitive transmission retrials that could not reach their destination. In very large audience interaction sessions several wireless channels can be used so that one channel is preserved for broadcasting session administration commands downstream to the user devices and one or more channels, each running a wireless line that allows managed replies from a multiplicity of user devices up to the upstream controller and middle stream guide devices.

There are three types of lines that the system supports: a) “Interaction line” for managing the interaction session with large audience; b) “Search line” for searching missing user/device(s); and, c) “Control line” for creating a mobile or fixed repeating line of user devices that can receive and send forward an emergency or control signal from an originating device such as an upstream controller or middle stream guide device down to the last device in the line.

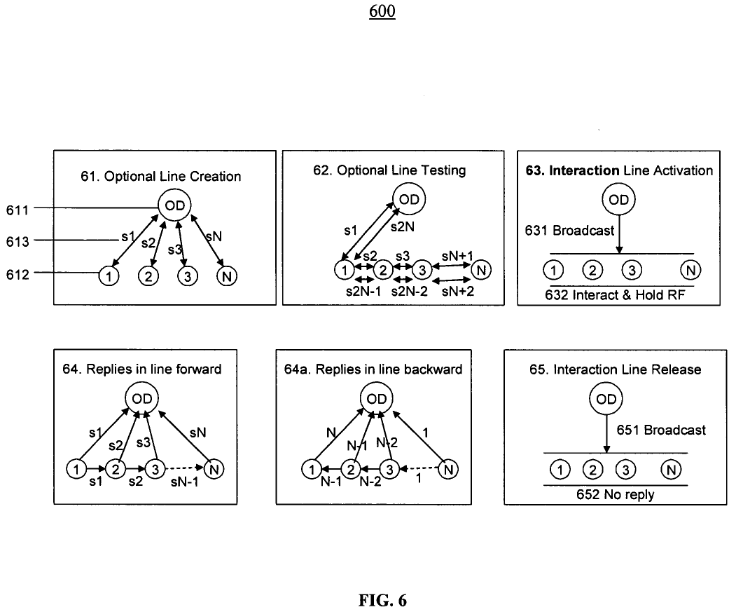

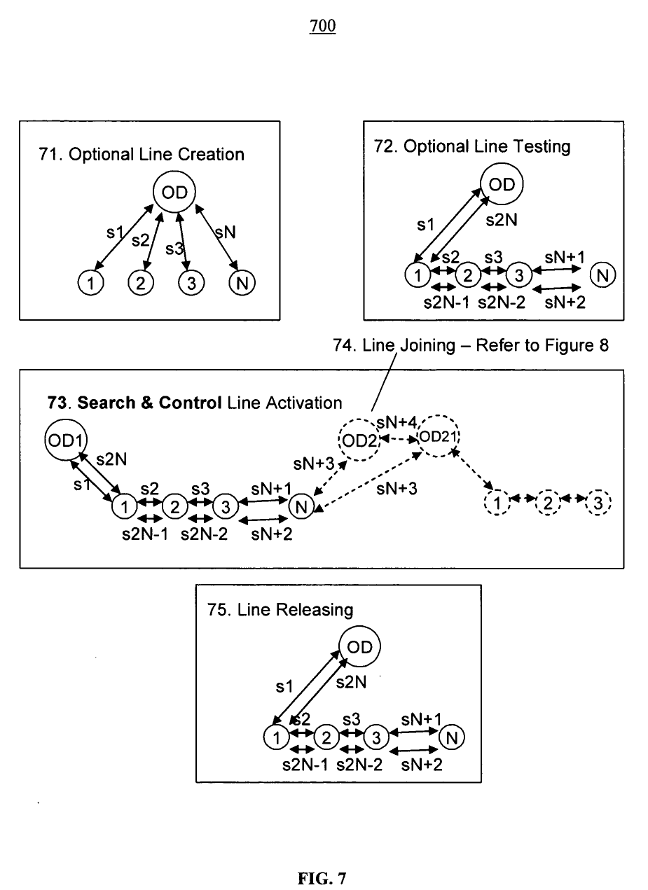

The process of handling line commands is the same for all three line types and comprises of the four steps of: a) “Create line”; b) “Test line”; c) “Activate line” mode (one of the three options); and, d) “release line” back to normal. FIGS. 6 and 7 are block diagrams illustrating the creating, testing, activating and releasing of wireless lines.

FIG. 6 includes a series of block diagrams 600 illustrating a method for wireless line management for interaction in accordance with an embodiment of the invention. In particular, FIG. 6 shows the “Interaction Line” wireless line method. In FIG. 6, box 61 shows the line creation process where there is an originating device (“OD”) 611 being initially the upstream controller that had registered all the participating devices in the line using its RFID reader and reading all the RFID tag IDs (long unique IDs) of the devices. The originating device 611 during the reading of the RFID tags it assigns a programmable PID to each device including the group ID and the short personal ID. The devices in line 612 that are taking part in the wireless line are numbered as part of the same group and having consecutive personal IDs. Device number two in the line knows that it will not send its RF signal out but only after it waited a timeout period after receiving device number one's signal. Device number five knows that it should wait until timeout duration after receiving device four's signal going out before sending its signal out. It also knows that it should wait three sending and timeout durations after receiving device two's signal going out. This allows the wireless line to keep and proceeding in signal sending even if one or more devices had not sent their signals out due to malfunction or absence or being out of range. Dialogs as in line 613 describe the two-way exchange of signals between the originating device and the user devices where the originating device teaches the programmable short ID onto the user device first, and the user device acknowledges by sending back its newly programmed short ID to the originating device. This dialog proceeds until all the group devices are programmed and acknowledged their order in the line.

Referring to box 62 in FIG. 6, it shows an optional line testing routine that either the upstream controller or a middle stream group device can initiate in the field in order to check that all users are properly programmed for wireless line functioning. The purpose of the test is also to identify which devices along the line are missing or are not receivable. The test does not require all the user devices to be in reception range to the originating device of the line test command. The process starts by sending the line test command; the first in line with the first programmable user ID catches the command s1 to send it forward with its own short ID. The second-in-line receives the command s2 with the first's user ID and keeps sending it with its own short ID to the next in line s3 that receives it and the process continues until the command reaches the last device in line. Even if one or more devices along the line are missing the next devices in line, after waiting enough as to allow the missing devices to propagate the command, they proceed with sending the command down the line. The messages from the originating device down to the last in line user device include the number of the last in line of that group. Thus each device in line compares this last-in-line's number to its own number and if its own number is lower than the last-in-line the message that is sent out is sent with a downstream indication 513 (see FIG. 5) still keeping the value 518 of the last in line intact. When the message reaches as in sN+1 to the last-in-line device, that device sees that its own personal number is identical to the last-in-line's value, starts the reply process, sets the value 518 of the destined device to 0. In step sN+2 which is the first reply message the indicator 513 is set to upstream and the devices in line are looking for missing devices. If for example device 4 is missing the message from device 5 is sent out, device 4 that is missing does not reply within the time window it is expected from it to respond, device 3 that is the next in line upstream who got the message from device 5, changes the value 518 to number 4 which was missing. The signal keeps being transferred even if there are more missing devices on the way with number 4 that was discovered as the first device missing on the way upstream of the line. When the message reaches from the first in line device upstream to the testing originating device, it knows that number 4 was missing. Now another line testing command is issued with a destined device 3 (which is 4−1) to check if there is no other missing device between the start of the line and the highest missing device. This process is repeated until all the missing devices in the line are discovered one after one and until the value field is returned with a zero value meaning that there are no missing devices between the last destined device during the last testing cycle and the originating device. Once missing devices in the line were detected the originating device 611 can initiate another line creation process as previously described but this time excluding the devices that were missing in the line testing process. Thus the new line becomes shorter and faster during the interaction sessions to follow.

Box 63 in FIG. 6 shows the interaction sessions where the originating device as in box 62 broadcasts an interaction session start. Broadcast is done by setting the destined address field of the message to all zeros as previously described. At the same time all devices in the destined group(s) are backed off 632 with any of their transmissions during the interaction session unless they have to reply as taking part in their turn within the in-line replies of box 64. During the interaction session all devices belonging to the destined group and in the same line start replying one after the other, device 1 replies first and both the originating device collects its interaction value (e.g. its voting value to a question of the interaction) and device 2 in the line gets the message from device 1 allowing device 2 to send its message out after a preset delay duration. Again the originating device collects the device 2's value and device 3 gets the message from device 2 so that it can send out its own message in the line including its own address as the replying device. The process proceeds until all the devices down to the last in line, number N, reply to the interaction session. Thus completing one session will allow the originating device to invoke another interaction session for replies collection in the line. The reply process is not limited to one direction downstream but as Box 64a shows it could run in similar method backward so that the last in line is set up to reply first and the first device in line is set up to reply last.

Box 65 in FIG. 6 shows the Interaction Line release step with the purpose of releasing the back off command to all the devices in the line throughout the interaction process. The originating device broadcast here to all the group(s) devices to enter their previous wireless mode. This previous mode can be one of many previously described (e.g. home alarm mode as in a universal remote control or back to a supervised mode where each device sends a heartbeat signal to a guide device every preset interval of time for presence check if this has been its previous mode before the interaction sessions). The devices in the line do not have to (but can if they are set to) reply to the broadcasting device for acknowledging that they returned to their previous mode of operation.

In case of a large audience interaction several groups can be managed by using the programmable personal IDs so that when the first group's personal IDs fill up the following group ID is opened and the personal IDs in it are programmed one after the other onto the registering devices. Registration of devices can be done either locally on an upstream controller or via the web and the web server into a database and programmed via the upstream controller onto the presently being programmed device using the RFID authentication as described above. If the audience is so large that the replies in a single interaction line may take too long, one or more RF channels could be initiated by the upstream controller where on each RF channel there could be several group of devices programmed to take part in an interaction line managed by the same upstream controller. In this case the upstream controller will broadcast in a reserved RF channel and the lines of devices will reply via several other RF channels to the upstream controller. Middle stream guide devices serve as reply collection mitigators in case that the large crowd becomes dispersed out of range from the upstream controller. Here the two broadcast steps 631 and 651 are carried out in two steps: in the first step the originating device 611 is the upstream controller that broadcasts to 612 that are the dispersed middle stream devices in the field that each one of them is in range with its groups of user devices that it administers; in the second step the originating device(s) 611 is the middle stream device(s) that broadcast to 612 that are the respective user groups being administered by them. The broadcast is performed in the second level of middle stream devices in the same method of line so that each middle stream device broadcasts to its groups when its turn in the line arrives. In the same cascaded way once all the replies from the user devices reach the respective middle stream device, the middle stream device sums up the values replied (e.g. all those answered value 1, 2, 3, 4 or else) and when its turn in the upper line arrives it sends the summed values to the upstream controller for grand totalling of all the audience results.

In principle the cascading of broadcasting and replies collection is not limited to two levels as described herein and could be enhanced to multi-level cascading using lines of middle stream devices. Thus the number of audience in the interaction session is not limited, the reply collection time will depend on the number of levels, the length of the interaction lines, and the number of channels used by the lines. In a concentrated audience setup like concerts the emphasis will be on number of RF channels to be used; in a dispersed group audience setup like a camp ground or military field setup the emphasis will be on more cascaded line levels for better range coverage.

Having described the operation of interaction lines, interaction input types that can be used by interaction lines will now be described. The interaction applications include a wide variety of contents such as edutainment for children and adults, voting sessions for tests, evaluation and voting sessions, quizzes, surveys, focus groups, ballots and games.

The interaction sessions between downstream user or middle stream guide devices and the upstream controllers include several types of interaction.

The known voting interaction as in a response system works so that the upstream controller displays a multiple choice question and within a period of time all the device holders in the audience can respond by selecting their preferred answer by pressing on the button that corresponds to the choice number or color or shape on the screen.

The known wireless mouse interaction method works as a single input device in front of a single screen user interface displacing the cursor image on the screen as a function of the device strokes to various directions. In this system the strokes are not the displacement on XY axes of a rolling ball or an optical sensor but it is the acceleration strokes on the XY axes that their magnitude that is sent via RF communication to the upstream controller that controls the screen make the cursor image on the screen move.

The known multiple wireless mice interaction method allows a multiplicity of wireless mice (either moving the cursor by XY displacement or XY acceleration) in the form of downstream user devices interacting concurrently with the single upstream controller controlling the corresponding cursor images to the wireless mice, all onto the same single screen.

Both single wireless mouse and multiple wireless mice can take part in an interaction line by having a time window to move their corresponding cursor image on the screen when their turn in the wireless line comes. The user knows that his/her turn in the line arrived either by having an indication on his/her device such as an LED turned on or by having a displayed indication of that user ID on the single large screen such as blinking of the corresponding cursor or showing the ID number of the user device on the screen.

The voice interaction method on the device works by detecting a sound generated by the device user that was input through the device's microphone. Thus in an interaction session displaying a multiple choice question the user can say into the device's microphone the word “Two” that will be recognized by the device's software to reply within the wireless message the reply value of two in the same way that pressing on button “Two” will set the value of two to be replied during the interaction line session.

The gesture interaction method on the device works by detecting a gesture performed by the user on the device and the accelerometer of that device recognizing the acceleration pattern along the XY axes to match to one of pre-recorded gesture patterns as previously described. A pattern matching the value “Two” will set the reply value of that interaction session and be sent out according to the message reply turn as part of the described interaction line.

Advantageously, all these input type methods are integrated as part of an interaction line as described above for a group or audience of any size.

There are four interaction session types with the audience in the system and these are:
a) “First Wins, A Single Interaction”. In this mode each user device transmits on the reply channel to the upstream controller a single reply including the device ID. The upstream controller as soon as it gets the first wireless message it decodes its originating user device, sends back a broadcast command destined to all the participating devices saying that the first replying device has been granted the right to control the output on the screen (e.g. select a multi-choice answer) and all the other audience devices will be backed-off until another release back-off signal was broadcasted. This session type does not use the interaction line method.
b) “All Reply, A Single Interaction”. In this interaction session type initiated by the upstream controller each user device can transmit a single reply and it backs-off until a release back-off broadcast command is received. Thus only one reply message is received from all the audience devices using the interaction line, they are counted and output by the controller on the screen.
c) “First Wins, Continuous Interaction”. In this mode each user device can transmit an immediate reply without using the interaction line method. The controller detects the first received reply by a device, broadcasts to all devices the ID of the first received device that was granted the right of continuous interaction and backing-off all the rest until a release back-off broadcast command is sent. Thus only the first received device has the option to continue and interact with the system during the current session (e.g. controlling the cursor like a wireless mouse).
d) “All Reply, Continuous Interaction”. Each downstream device can transmit one reply or more continuously; the controller receives all these replies, aggregates the replies for each selected choice, displays the results and acts according to these results per a predefined rule.

The user devices allow taking part in the interaction by activating one or more of the interaction input types, resulting in deterministic codes that are transmitted wirelessly to the system controller that acts accordingly and feedbacks on the screen and on other outputs. Examples for these transmitted codes are: a) pressing on yellow button sends interaction by input code 2; b) activating input 3 interfaced to the device sends interaction by input code 3; c) pressing on the blue button, moving the device as per taught gesture number 1 and releasing the button sends interaction by gesture code 1; d) saying a word as per pre-taught sound number 2 to the device sends interaction by sound code 2; and, e) a combination of inputs as in example c) and d) sends a combined interaction by gesture code 1 and by sound number 2.

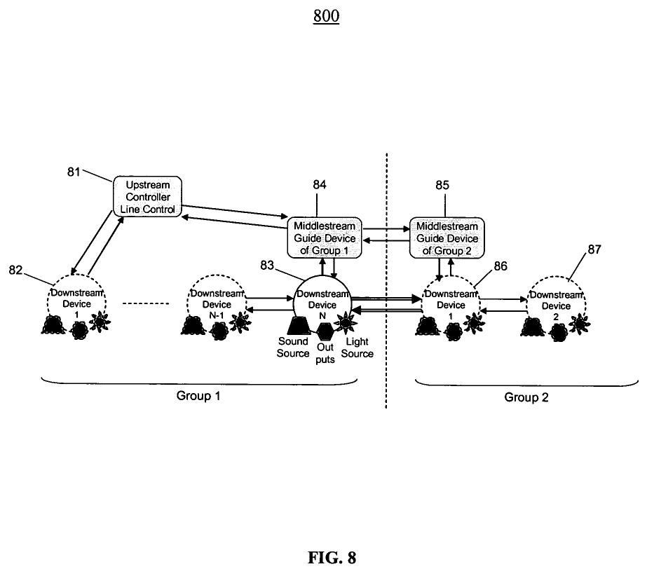

FIG. 7 includes a series of block diagrams 700 illustrating a method for wireless line management for search and control in accordance with an embodiment of the invention. In particular, FIG. 7 shows the “Search Line” wireless line method. The search line related processes include: a) Search Line Creation process as in box 71 is identical to the Interaction Line Creation process as in box 61 that was described above; b) Search Line Testing process is described in box 72 and is identical to the Interaction Line Testing process as in box 62 that was described above; c) Search Line Activation process is described in box 73; d) Search Line Release described in box 75. Line joining process 74 will be further described below with reference to FIG. 8.

The main difference between the Search Line and the Interaction Line is that the Search Line uses the devices in line to mainly extend the RF range during the search process while the Interaction Line uses the devices that are usually in range to better administrate the flow of the numerous messages of a large audience.

In box 73, “Search Line Activation” is done from an originating device OD1 being either an upstream controller or a guide device that sends the command downstream s1 to the first in line device 1 including two IDs, one is the destination first in line device ID and the other is the searched device's ID. The first in line device stores in the memory the searched device's ID and sends the command destined to the next in line device's ID that was stored previously during the line creation process. This sent command is also a confirmation to the originating or previous in line device that the signal has been received and that the process of activating the line is proceeding. If this confirmation has not arrived there would be a message send retry by the previous in line device. The second in line, device 2, that receives this command further sends it downstream the line and the process proceeds until the command reaches the last in line, device N. Then the last in line device replies with a signal including two IDs, one including the destined, which is the previous in line device ID N-1, and the other is the last in line's ID that has received this Search Line Activation command and when the command reaches back the originating device it serves as proof of command receipt that reached all the way to the last in line.

The “search line” process starts and each time duration the devices in line send a “search” command destined to the searched device ID, expecting its response. Assuming that the actual search line of devices moves forward either by walking or by driving within visual and within wireless reception range from each other create a searching frontier that scans an extended area as broad as the distance from the first in line's wireless range to the last in line's wireless range.

The “Search Line Release” process shown in box 75 of FIG. 7 when initiated by the originating device cancels the line function mode and allows the user devices to function according to their previous selected capabilities. This “Line Release” process advances in an identical controlled sequence of the “Line Testing” process as shown in box 72 assuming that the in line devices are distant apart of each other and that a broadcast message cannot reach all the in line devices at once.

The “Control Line” related processes are similar to the search line processes and the main difference is that there is no sending of any missing device's ID. Instead each device in line can activate a control button or interact by one of the means described above and this signal can propagate upstream along the devices in the line until they reach the upstream controller that takes further action. This control line can support low-traffic activation of commands and can be used for emergency or remote control applications with extended range using user devices as repeaters.

The control line related processes that are similar to search line related processes include: a) “Control Line Creation” shown in box 71 that is identical to the Search Line Creation process; b) “Control Line Testing” that is shown in box 72 is identical to the Search line Testing process; c) “Control Line Activation” shown in box 73 is identical to the Search Line Activation process; d) “Control Line Release” that is shown in box 75 is identical to that of Search Line Release process. The “Line Joining” process 74 will be further described below with reference to FIG. 8.

The control line can be also activated first by the upstream controller that broadcasts a command to all the devices in the line to start a function, receiving acknowledgement from the last in line device that received the command and accomplished the command. Example for this application can be remote controlling a line of electric light poles to be turned on or off. The system controller can also address and activate a destined repeater ID in the line to perform a certain action for example send an interaction signal to nearby remotely controlled devices.

Note that the physical order of the users in the line shall be kept at all times during the session so that device(s) do not go out of their orderly wireless range from their adjacent device(s) in line.

FIG. 8 is a block diagram 800 illustrating a method for wireless line joining by upstream/middle stream devices in accordance with an embodiment of the invention. By connecting the last in line device of one group to the first in line device of the following group, the line can be further extended. In each group the order of the in line devices had to be defined by an originating device prior to the line activation. Middle stream guide devices of the two joined groups create the wireless bond between the two groups. This way the line joining is created in agreement and in a better controlled way by the group guide authorities (e.g. teachers) and not created by in line user devices (e.g. students). It is also recommended that middle stream guide devices be near the wireless lines of devices so that they could release, recreate and test the line if it becomes necessary after a pause or breaking the line beyond the wireless range at a certain point.

The wireless lines' joining is carried out in the following process. For each one of two adjacent groups of user devices a line is created by the originating device OD in box 71 that is also the upstream controller 81. A middle stream guide device that belongs to a specific group has the total number of user devices in its line following a “Line testing” per box 72 process or “Line Creation” per box 71 process. The middle stream guide device of group 1 84 initiates a “Join Line” command destined to other middle stream guide devices around. This command includes the group 1 ID, the originating group device ID, the number of user devices in it which is also the personal ID of the last in line of that group 1. All the other group's middle stream devices can respond to that “Join Line” command by pressing on “Join Line Accept” option. If middle stream group device of group 2 85 presses on the “Join Line Accept” option it sends a message destined to device 84's ID, including the group 2 ID, the replying device 85's ID and the first in line device's ID in group 2. Now that both guide devices of group 1 and 2 have both the device's IDs—the last in line of group 1 and the first in line of group 2 they can issue a “Teach line link” command to their respective user devices to teach them the group ID and device ID of the device they should be linked to, such that the first in line device of group 2 86 is always downstream to the last in line device in group 1 83 during a line command activation.

An example of using a joint line can be the upstream controller 81 sending a control message to turn on the output 3 on device 2 of group 2 (device 87) while using all the user devices in the joint line as repeaters that pass the command and confirm back the command activation on the destined device. The line can be extended indefinitely to many groups of devices joint one after the other and the only limitation for the line length is the group and device IDs' bit lengths to identify the destined device.

The same extended line can be used to create a search frontier of moving and searching user devices that once every time interval while moving they issue a “Search” command of a missing device and thus covering a broad area that the missing device can be found in.

The system supports presence “Check”, “Missing” alert, “Search” process, and “Found” messages. Another advantageous feature of the secured modes of operation is related to the process of user devices' presence check, detecting if one or more of the user devices is missing, subsequently searching the missing device(s) and releasing the alert situation once the missing device(s) is found.

All group members, user devices following their first daily entry event to the class, either by checking-in at the upstream controller or by soft entry process while waiving to one of the guide devices, start to act in a supervised mode, meaning that they start transmitting a “heart-beat” signal every period of time in order to say to their group controller or guide devices that they are present. The presence signals and their ‘last appeared’ time from each one of the group members are continuously recorded by the upstream controller and the middle stream group devices that are the supervising devices. If a presence signal from a group member is not received for a preset period of time, which is several times greater than the interval between every two presence signals, the supervising device sends a “Missing” alert with the missing group member's ID. When this “Missing” message is received by other groups' middle stream devices they issue the message again and thus the message range gets extended to try and find the missing device. When the missing device responds and is received by a middle stream device this becomes the first “found” message, the finding device reissues a “found” signal together with the found member's ID and the supervising device's ID as an indication of the location (since usually the location of the middle stream guide devices are known such as teachers in school classes). The purpose of the “found” signal is to stop other supervising devices from searching the found member and update the “found” time in their databases. During the period from “missing” alert to “found” signal the supervising devices show on their displays the time and the message “Missing” together with the name of the missing member. When the member is found the supervising devices show on their displays the time and the message “Found” together with the Name of the found member. Thus the “Missing” process is terminated but recorded for future reference. The information on the time of missing and found, the ID of the missing and of the finding devices are recorded on the middle stream devices until they download this information at the end of the day (or period) onto the upstream controller that can issue the time and attendance reports in that facility (e.g. school).

If the missing member is not found for a certain period of time that is programmable, there is a capability to issue either manually or automatically a “SEARCH” signal that extends the search by adding one or more of pre-programmed several options: a) Extending the reception range of signals that may return from the missing member by adding the other groups' supervising devices to join the search; b) increasing the transmission strength of the “SEARCH” signal; c) increasing the reception sensitivity on the receiver of the missing device after a period of time that it is missing and not receiving any acknowledgement signal from a supervising device; d) pre-programming all groups and all member devices to “back-off”, to stop any transmission of signals in case they receive a SEARCH signal and their ID is not equal to the specific ID sought by the SEARCH command. A “Found” command issued upon missing-member-detection turns back the working mode of all devices from “back-off” to normal; e) Adding all group's user devices along a “search line” and thus extending the search range as described above; f) Joining more groups along the search line in order to extend further the search range as described above.

The assumption in this method is that when you receive the reply signal from the missing member it is possible to find him/her within the reception range of the signal or at least to focus the searches in the area of the device that found the missing member.

This application can be used also as part of “inactivity alert” for elderly in nursing homes in cases where the elderly presence signals are not received for several cycles of presence signal sending periods.

Another application of this presence checking feature is for animals, assets or container checking. The middle stream guide device broadcasts a “check” command and all objects carrying a dual wireless module reply repetitively their IDs every certain time duration until a “receipt confirmation” signal is received from the guide's device. The middle stream guide device not only counts how many have replied, it gets their IDs, and detects which object ID is missing by comparing the received IDs to the list of stored IDs in its database. If certain objects were not received their ID appear on the middle stream guide device's display that can execute the “Missing” alert sequence and if still not found the “Search” process as described above. When missing object is found, the middle stream guide device broadcasts a global receipt confirmation to the transmitting devices so that they stop their repetitive transmission. In case one device's reply is not received the middle stream guide device sends a “Check” command forwarded to that specific device's ID only.

The system also supports “Superguides”. Setting a middle stream guide device as a “Superguide” has the purpose of cascading system commands in an organizational hierarchy. The Superguide device is also mobile as the guide device and it collects and aggregates results from several guide devices that are in either of the processes of mobile access control, interaction, counting, searching and others that are described above. The Superguides have a separate group ID that identifies them as such and in their group they have several or all group guide IDs, thus creating a cascading or a hierarchy effect for mobile scalability and improved administration of the system's functionality. Applications of Superguides functionality are: a) going on a school trip with several school buses; b) multi-level or multi-team strategic games; and c) commanding army troops in the field.

A certain middle stream guide device can serve in a Superguide mode in one organization (e.g. principal in a school), in a Guide mode in another organization (e.g. coach of a sports team) and in a group member mode in another organization (e.g. a trainee in a gym class). When the middle stream device is not checked into any organization it has the default remote control functions available. Entering and checking-in into one of the organizations by either of the two methods described above (RFID or RF) the device's functionality switches to the appropriate mode. Exiting and checking-out from that organization by either of the two methods (RFID or RF) the device's functionality switches back to the default remote control mode.

The system also supports personal commands and applications. One such application is the personal emergency alert. Personal emergency applications are widely used. The following are the known options that are featured in the system of this invention:
a) E911—upon a push or a continuous push on the designated button sends an RF signal for emergency that when received by the system controller, activates a report to the E911 either by text or by voice message.
b) Mandown—an RF mandown alarm signal is executed following a tilt-switch exceeding a certain predefined angle for a certain time without being reset to the upright position on dual wireless devices, user devices and guide devices while carried by their users. Same signal applies when mandown was detected by an accelerometer that is on the device.
c) Temperature—exceeding the minimum or maximum preset allowed environmental temperature will send a “temperature alert” signal.
d) Inactivity—In case that no motion is detected at all on the device, meaning that the device user carrying the device did not move for longer than expected, an ‘inactive’ alarm signal is sent.

The following is a method of personal emergency activation is accordance with an embodiment of the invention:
e) Panic gesture—Similarly to gesture signature recognition as described in the Dual Access Control method above, a specific user gesture is taught so that when performing this gesture the device parameterizes it to match with the pre-recorded gesture and if there is a match a panic alarm is issued accompanied by the ID of the user via RF communications.

The system also supports a universal remote control application. Most of the RF remote controls for cars, garage doors and alarm systems are carried by their users in key rings or placed in the overhead compartment in the car. These remote controllers may be incompatible with each other and require from the user to carry several devices. Worldwide standards require the use of different frequency bands for these RF applications. The latest technology advancements and RF chips available in the market allow producing a single device using a single RF chip that can work in several common frequencies complying with the worldwide standards. These RF chips also enable switching between various frequencies and modulation types as necessary and on the fly using wireless signals that command this switching. The RF parameters on the dual wireless devices and repeaters in this system can be switched between RF protocols by broadcast commands and thus become compatible with various models of remote controls commonly used in the market. In certain sensitive applications where code secure methods are applied such as in car or alarm system controls, the user and guide devices will have to support these protocols in order to be compatible with these applications. The system controllers allow downloading the information that characterizes the desired remote control protocol to the user and guide devices, which can activate using the push buttons, the commands corresponding to those on the other remote controls. For example the four colored buttons on a simple user device can be programmed to arm, disarm an alarm system and open two garage doors in the home system from a certain manufacturer. On guide devices there can be more than one wireless remote control protocol that can be switched to and supported by it, one for the car, one for the home alarm and one for the alarm system at work.

The embedded Infrared transmitter can be also programmed on the guide device option for the TV or VCR set as in known universal remote units. The guide device can set the remote control option to activate the IR remote control function of the preset parameters to control the TV or VCR.

The system also supports a “Who are you?” function. This is a system feature where each of the middle stream and downstream devices in this system have stored in their memory textual information about their personal identity, belonging group identity, locations, phone numbers and more. When two users meet and at least one of them carries a guide device or a system controller including display screens, this user can initiate a ‘Who are you?’ command to the other user that replies by sending via RF communication one or more of these textual information for screen display and identification.

This way a found device or a found user carrying a device can be easily identified and returned to its original owner or sponsor.

The system also supports a “Where are you?” function. This is a system feature where the dual wireless devices have stored in their memory, textual information about their last, their temporary and their permanent locations. When a user carrying a guide device including a display screen, this user can initiate a “Where are you?” command to a destined device ID that replies by sending one or more of these pieces of textual location information for screen display.

This way when positioning a single or a group of animals or assets or containers at a certain location, a guide device sends the command “Teach Location” with the textual location ID to be stored on the dual wireless device that is attached to the object or on the group of dual wireless modules or devices that are attached to a group of individual objects. Later on when the guide is in the range of the located object he/she can send a “search” command destined to a specified device that returns its taught location name. In case there are “k” limited location IDs and “N” a large number of objects to store the guide device has to memorize k+N fields (close to N) only and not 2N fields, N fields of object IDs and N fields of their locations. The single location information is memorized on each of the object devices.

The system also supports digital watch functions. For guide devices with LCD that can display text, the default display shows the time and date in digital format. Pressing on the Menu button repetitively reaches the menu entry of Setup and Watch, where the hours, minutes, seconds, day, month, year can be set by incrementing and decrementing the digits using the push buttons. The local time, chronometer and alarm reminder can be locally set similarly to a digital watch.

From the default time display the user can scroll on the watch the main menu items by pressing repetitively or scrolling the thumbsync Menu button. When the user selects by pressing on each of the four buttons on the device the user gets the corresponding menu entry. By pressing more than one second on each of the four colored buttons on the guide device the user gets another set of four more entries in the main menu to select from. All the digital watch functions are set and displayed locally on the watch, independent of any controller.

Special health monitoring sensors can be integrated to offer various display and reporting services of: a) Body temperature; b) heart rate; c) heart rate irregularity; d) blood pressure; e) inhale-exhale rates; f) blood oxygen level. The pill reminder option using the alarm function can be used as part of the health monitoring services.

The system also supports information sync with the controller. All the devices in the system have the capacity of synchronizing textual information with the upstream controllers using XML or another format. The user can move information into the “Sync” basket on the computer software or on the web software for the data to be transferred to the device. The information records include: a) current time and data on the controller; b) Individual short ID of the device in the group; c) Individual user name; d) Individual current location; e) Group controller's RFID unique code; f) Group short ID; g) Group name; h) Group permanent location; i) Group current location; j) Organization/Affiliate name; k) Organization location name; and, l) Call number and more. A device can have a principal set of data, which is synchronized with the principal system controller. When a user of a device becomes a member in several groups or organizations the sync function enables the information exchange between a current system controller and the device and the device can hold several secondary sets of data from organizations other than the principal one.

The functions “Who are you?” and “Where are you?” that are described above and are received by a device, are replied with the textual values that reside in the devices' data fields and their purpose is identification and location of its user.

The system also supports e-wallet, e-payment, and “Infojection” functions. The guide devices can function as a full electronic replacement of a wallet. If a wallet includes photo IDs, other ID cards, credit and charge cards, cash payment means, telephone cards and information means for calendar, tasks and notes, all these could be stored and activated by guide devices.

The photo of the user with his/her signature, name and ID number is produced and attached in a controlled way to one side of the device case. These can be provided for example by the web service authorization organization or by national social security or provincial driver license issuing body.

The calendar events, appointments and tasks could be displayed on demand or when their reminder time is due on the device small display screen in a shortened and a scrollable format.

Each individual user can enter his/her personal e-wallet information following an authentication that includes a personal ID and password that could be done from any web terminal while the download of the selected pieces of information are carried out from a system controller that the user has access to via RF communication. Any information download time and location are stored on the web server host for future security and reference purposes.

An automated process for information injection from the wireless device to the web server via the upstream controller is referred herein as “infojection”. In this process the page on the web page screen has the function to initiate a “get infojection” command where the downstream or middle stream device can send via the upstream controller its personal details, business card, resume or other type of stored information to the respective fields on the screen. Thus a user when browsing a page with repetitive information fill-out can automatically fill these information fields by a single press of a button (or by other means of interaction like waving the device or speech detection) given that the page is “infojection” enabled requesting the data and the data had been stored on the device. A special matching standard can control the requested fields from the “infojection” enabled page that are sent to the device which returns the contents of these fields in XML or another format.

The ID and payment cards information can be verified by the process of approaching with a user or guide device to the RF transceiver/RFID reader that are either in the upstream controller or in the repeater. The reader reads the RFID and then asks via RF for information verification for the type of card that is requested, for example for payment credit/debit card options, for access to the library—the library card ID etc. The device replies by the information of the requested card if it exists and valid in its database. An authorized transaction is then executed and an action from the reader device is done, such as opening the gate, allowing the charging of a calling card on a public phone, printing the payment transaction receipt on a point of sale reader, etc. “Infojection” enabled payment terminals can also initiate an e-payment transaction by sending an “Get Card Infojection” command to the device that replies using RF with the credit card number to proceed the payment transaction on the terminal.

The system also supports single-click functions. Single click or press of button functions programmability is possible both on the system controller and the guide device side. The objective is to provide simple means of querying and activating repetitive or special actions into a single stroke on the wireless device. Examples for these functions are not limited to: a) querying the current weather forecast from the Internet via the system controller or another guide device; b) receiving and displaying it on the requesting guide device by a single click; c) programming one or more car unlock commands as a remote control keyfob and activating them by a single click; d) programming a dial-up number or an input PIN number for identification as a single click “infoject” action to a phone or to a point-of-sale (POS) that supports a tone interface or the system RF interface; and, e) programming in advance a set of answers and pauses between answers for a continuous voting or quiz response session so that all the answers are sequentially sent via RF communication as a result of a single click.

There are “Set control combo” function on the system controller and the guide device that enable recording of a sequence of functions as a macro that could be later activated by a single click of a button.

The single click functions could be synchronized and taught from the upstream controller or from one middle stream guide device to another or to a user device that could perform that same action while preserving his/her own identity during the function activation. For example if a single click on guide device 1 performs a sequence of three RF signal sending out the device's own user ID attached to it, after teaching this single click command to device 2, device 2 will perform the same three RF signal sending accompanied by device 2's own ID attached to it.

Teaching single-click functions from guide device to another guide device or user device using RF communication is an advantage of the present invention.

The system also supports content control and object selection. Using the guide devices buttons and gesture recognition functions one can interact with various types of contents like a wireless 2D and 3D mouse.

Using the four color coded buttons as “Enter”, “Next”, “Previous”, “Back” one can navigate on the screen with the help of a color coding legend display, where the “Next” and “Previous” navigate to objects in the same level, “Enter” drills down to one level below the current one (in cases also opening the contents of that level members), “Back” backs up to one level above the current one (in cases also closing the contents of that level members). Examples for navigating in 2D and 3D trees are not limited to: a) Hierarchical folders and files (like in Microsoft Explorer); b) Family trees; c) Organizational charts; d) 2D or 3D assemblies of mechanical parts zooming every time on the selected sub-assembly and its members.

Using the four color coded buttons with the gesture recognition functions one can navigate on the screen with the help of a color coding legend display. Examples are not limited to: a) 2D maps, graphics and drawings panning; b) 2D maps, graphics and drawings zooming in and out and panning to all 2D directions; c) 3D object rotation around the object origin continuously towards left and right but towards the top and bottom until the polar points; d) 3D view rotation around an origin continuously towards left and right but towards the top and bottom until the polar points; e) Fly-over a 3D model by steering left and right, up and down; f) Drive a vehicle on a race track, steering left and right and speeding up and down; and, g) controlling toys with wireless transceivers by steering two functions, each up and down or left and right.

A fast object selection method, with “Log n” steps is implemented by color or number coding of a large number of objects on the controller's screen, where “n” is the number of buttons on the selecting device. In this method the “X” number of objects in a list or on a catalog are categorized or divided arbitrarily within “n” groups on the screen. The audience by pressing on one of the buttons (or initiating a numbered interaction means such as gesture, voice, video pattern as previously described) selects the corresponding group color or number. The group members are then categorized or divided arbitrarily again as part of “n” groups on the screen and this process continues “Log n(X)” times until the requested object was selected by the audience. Using the interaction methods described earlier in this document interesting contents, games and interaction sessions can be created and followed.

The system also supports the download of a coded melody. Another feature in user devices is the ability to download simple coded melodies from the system controller or the guide device. The simple user device owner when enters through the device controller and is registered by the RFID reader, it gets via wireless communication a series of coded notes (via XML for example) composing one or more melodies. These melody streams can represent a permanent song on the user device (e.g. the national anthem) and a daily downloaded melody (e.g. the “song of the day” for the class' children to learn). Once the melodies are in the user devices, the guide device can broadcast to all the user devices in the group to start playing. Playing certain melodies following a broadcast command to all user devices in the audience create interesting audible feedback effects to interaction sessions held by the system.

The middle stream guide device can also download the fixed or the daily melody to one or all the users from his own device.

The process of downloading one or more melodies to a multiplicity of devices via wireless communication then after the download broadcasting a command to start or stop playing downloaded melody identification is an advantage of the present system.

The system also supports RF testing. Guide devices are capable of providing an RF testing device for the guides on site. The guide can select this function, send an RF-Test command to all the group's devices and when the replies are received for each reply the RSSI signal strength level is sent. The guide can scroll the display to show the received devices IDs and their signal strengths one after the other and discover those devices that suffer from shorter range, RF disturbing location or any disturbance during their transmission. The signal strength is either expressed qualitatively as “excellent”, “good”, “mediocre”, “weak” or quantitatively by value or percentage of the maximum potential value.

The system provides several interaction methods. One method is the “4*4” evaluation and matching method. A significant type of content for interaction sessions are multiple choice sessions such as trivia games, tests, evaluations, polls, and other edutainment related contents.

The evaluation and matching methods described below include three types of components: a) a software engine residing locally on the upstream controller or as a web service that enables to create online, multiple choice surveys for session interaction via the upstream controller; b) a web service that displays the created survey during the interaction session on the upstream controller; c) an aggregation and reporting tools that provide the total results for individuals and the group interaction sessions.

The software engine can create three types of surveys: a) questions with multiple choice answers; b) set of evaluation clauses with a series of gradual ranks from “weak” to “strong” or from “strongly disagree” to “strongly agree” where the scale may have 2, 3, 4, 5, 7 choices that are the same for all the questions in the evaluation set of questions; c) a series objects that are being compared based on the same type of parameters to a reference object. This reference object being usually a person is evaluated first by the audience or by the person's own judgment, the evaluation scores of the reference object are displayed on the screen and then each of the evaluated series of objects is ranked by the same parameters to find a possible fit with the reference object.

Although the number of choices can be between 2 and 7 the recommended number in this method is 4 since: a) it provides enough choices to choose from; b) it has no middle choice so that it forces the user to make a decision between rank 2 or 3 and not choose the middle rank as default; c) it makes it simple for the decision than if there were 5 or more choices.

The “4*4” (or “4\hat{ }4” or “four by four”) evaluation and matching method of the present invention can be used as a tool by an individual or as a game played by a large crowd all having a wireless interactive device. The method can serve reaching a better alternative choice in a purchasing process while comparing the given alternatives (or samples) to the existing choice being set as the reference object. This method also can serve as a mate matching tool or a game as is further described in this invention below.

The method includes three steps in the process: a) Selection of the parameters that will be the basis for the matching, for example the four parameters for evaluating a bachelor in a dating game (e.g. appearance, personality, intelligence, background); b) Selecting the profile of ranking that the reference object and the series of objects will be ranked upon, for example Linear profile, Normal profile, Exponential profile and Biased profile; c) Matching assessment by comparing each of the parameter rankings and total ranks of the reference object and the current object.

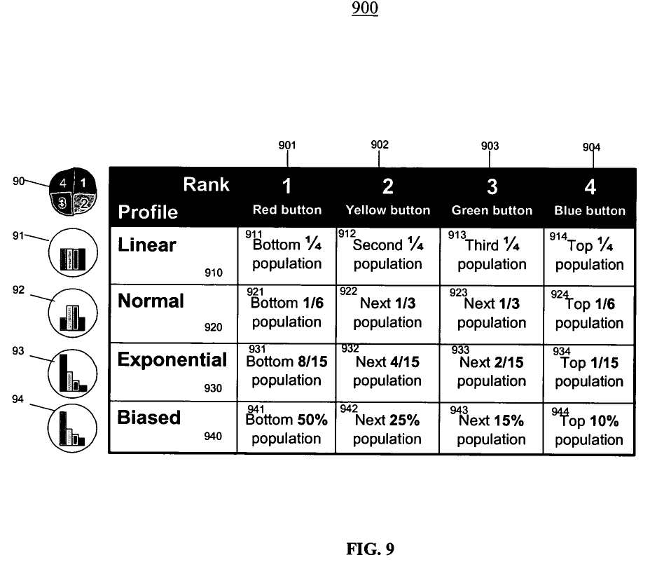

FIG. 9 is a table 900 illustrating profiles and ranks for a matching method in accordance with an embodiment of the invention. The profiles include in this example four ranks for each one of the four profiles; however, this can be a different number for both ranks and profiles. Circle 90 shows the rank selection between 1 and 4 corresponding to the position of the buttons on the user devices held by the audience. Circle 91 graphically depicts the Linear profile line 910 according which the bottom ¼ of the population (in cell 911) gets the rank 1 (of column 901), the second ¼ of the population (in cell 912) gets the rank 2 (of column 902), the third ¼ of the population (in cell 913) gets the rank 3 (of column 903), and the top ¼ of the population (in cell 914) gets the rank 4 (of column 904) in a selected parameter.

Circle 92 graphically depicts the Normal profile line 920 according which the bottom ⅙ of the population (in cell 921) gets the rank 1 (of column 901), the next ⅓ of the population (in cell 922) gets the rank 2 (of column 902), the next ⅓ of the population (in cell 923) gets the rank 3 (of column 903), and the top ⅙ of the population (in cell 924) gets the rank 4 (of column 904) in a selected parameter.

Circle 93 graphically depicts the Exponential profile line 930 according which the bottom 8/15 of the population (in cell 931) gets the rank 1 (of column 901), the next 4/15 of the population (in cell 932) gets the rank 2 (of column 902), the next 2/15 of the population (in cell 933) gets the rank 3 (of column 903), and the top 1/15 of the population (in cell 934) gets the rank 4 (of column 904) in a selected parameter.

Circle 94 graphically depicts the Biased profile line 940 according which the bottom 50% of the population (in cell 941) gets the rank 1 (of column 901), the next 25% of the population (in cell 942) gets the rank 2 (of column 902), the next 15% of the population (in cell 943) gets the rank 3 (of column 903), and the top 10% of the population (in cell 944) gets the rank 4 (of column 904) in a selected parameter.

The possible ranks per parameter can be integers of 1 or 2 or 3 or 4 only (in this example). The total rankings can be integers between minimum of 4 (four times 1) to a maximum of 16 (four times 4). In certain cases that are allowed by the session administration the rank can show 0 to say that the ranking is not voted for or unknown, and then the potential maximal total is reduced by four as not taking into account that parameter in the overall calculation.

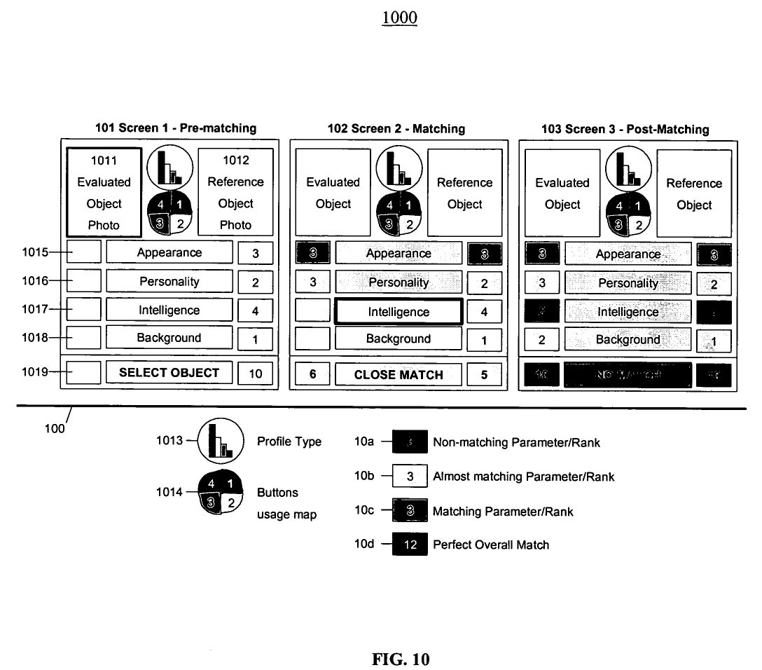

FIG. 10 includes partial screen captures illustrating a graphical user 1000 interface for the matching method in accordance with an embodiment of the invention. FIG. 10 may be used to describe the matching method through its three major steps. Above the line 100 there are three screen views: Screen 1 101 that shows the pre-matching phase; Screen 2 102 that shows the matching phase; Screen 3 103 that shows the post-matching phase. In all three phases the structure of the screen is the same, it includes in box 1011 the currently evaluated object's photo or description; in box 1012 the reference object's photo or description; and in lines 1015 to 1018 the parameters for ranking for both the reference object and the currently evaluated object. The rankings for the currently evaluated object reside under its box 1011. The rankings for the reference object reside under its box 1012. In between these two columns of rankings the evaluated parameters show, in this example the four parameters are Appearance, Personality, Intelligence and Background. Line 1019 shows in the same line format the total ranking of the currently evaluated object under its ranking column; the total ranking of the reference object under its ranking column; and under the parameters boxes the status or indication to the audience what to do next in the process (e.g. in screen 101 indicating the crowd to ‘SELECT OBJECT’). Between boxes 1011 and 1012 there are two indication circles, the first 1013 is the profile type that has been selected (either by the session administration or by the audience; in this example the profile type is ‘Biased’ profile 94) for this matching session (e.g. Linear, Normal, Exponential, Biased or other profile from the library), and second 1014 that shows which buttons the users have to press on their user devices in order to select ranks 1 to 4.

The process starts in 101 when the reference object for the matching is selected (either by the session administration or by the audience) and its photo or description is visually shown in Box 1012. Then the audience vote parameter after parameter their rank using their user device buttons. The first parameter's interaction session of “Appearance” allowed the audience to vote their choices and the system after receiving all the votes averaged the received votes to a total rounded score of 3 in line 1015. The interaction sessions proceed to complete the voting for the other three parameters so that for “Personality” the total rank is 2 in line 1016, for “Intelligence” the total rank is 4 in line 1017, for “Background” the total rank is 1 in line 1018. The total rank is summed up to result the rank 10 in line 1019, from minimum total ranking of 4 and maximum total ranking of 16.

The voting decision process for each user in the audience per the object's parameter ranking is as follows:
a) Knowing the object that the audience is voting on per the current parameter. In order for the audience to become familiar with that parameter of the object being voted for there might be an interview or a video clip showing the object as such that the audience could have a judgment on the voted parameter about that object. If the user does not know enough the evaluated object and cannot make a sound judgment to rank it, and if the option is allowed by the session administration, the user can vote 0 (to say “I do not” know).
b) Classifying the object per its percentile in the required parameter within the population and according to the current ranking profile. For example if an object is subjectively evaluated by the user to be in the 77th percentile of the “Intelligence” parameter within the population, and the current ranking profile is “Linear”, the user will vote the rank 4 for the top 25% of the population. However if the current profile is “Normal” the user will vote the rank 3 being one level below the top ⅙ of the population according to what the “Normal” profile determines. If the current profile is “Exponential” the user will vote the rank 2 being below the 80% of the population that differentiate between rank 2 and 3 in this profile.

The next part 102 of screen 2 shows the process of evaluating an object by the same parameters and comparing its ranking to the ranking of the reference object. In line 1015 of screen 102 the evaluated object received a total rank of 3 on “Appearance” which apparently matches the rank of the reference object. In this individual rank match situation both rank number boxes become green by the legend box 10c below the line 100. In the next evaluation session of the evaluated object for “Personality” it received a rank of 3 in line 1016 of screen 102. Since the evaluated object's rank of 3 is 1 number distant from the reference object's rank of 2, both rank number boxes become yellow by the legend box 10b below the line 100. Screen 102 shows that the process is in its third interaction session before completing the collection of the ranks for the evaluated object on the “Intelligence” parameter. The ranking sum until that session, which includes only the two first parameter rankings is 5 for the reference object in line 1019 of screen 102, and 6 for the evaluated object. This situation so far shows a difference of 1 between the total ranks and therefore it shows the rank number boxes in yellow and indicates “CLOSE MATCH” between the two being matched objects.

The last part 103 of screen 3 shows the end result of the matching process between the reference object and the currently evaluated object, where the last two parameters of “Intelligence” and “Background” have been voted for by the audience showing 2 for “Intelligence” and 2 for “Background” and where the total of both objects is 10. Note that although the total 10 of the reference object matches the total 10 of the evaluated object there is no match between the two and the indication line is colored red as per legend 10a of “No Match” under line 100. The reason for that is that in the individual parameter of “Intelligence” the audience voted 4 for the reference object and only 2 for the evaluated object and the difference of 2 or more creates automatically a “No Match” situation between the two no matter what are the other parameters' matching situation and even if the total ranking turned out to be matching.

The matching process has four rules of matching:
a) No match—where the difference between the reference object and the currently evaluated object of any one parameter rank or of the total rank is 2 or more. “No match” causes a red color indication on the screen.
b) Possible match—where the difference between the reference object and the currently evaluated object of a parameter rank or the total rank is 1. “Possible Match” causes a yellow color indication on the screen.
c) Match—where the ranking of a single parameter of the reference object and of the currently evaluated object are the same. Match is also where the total ranking of the reference object and of the currently evaluated object is the same while having different individual parameter rankings. “Match” causes a green color indication on the screen.
d) Full Match—where the ranking of all individual parameters of the reference object and the currently evaluated object are the same and hence resulting in the same total rank. “Full Match” causes a blue color indication on the screen.

The color indications could take place in the rank number or box or other parts of the screen. Instead of the color scheme described above a shape-based scheme or a combined color and shape-based scheme could be used for indicating the result of the matching process.

During the matching process the display may include audiovisual effects that affect the whole screen or the areas of the objects displayed and they are associated to the matching level. These effects can include: a) the change of color; b) change of shape; c) playing a sound or music; d) playing a visual animation; e) playing a video clip. For example when the rank of the currently evaluated object is collected by the upstream controller from the voting audience and calculated to be matching to the one of the reference object, a corresponding video clip starts to play on the screen.

This evaluation and matching method can be applied not only for a large audience votes using wireless user devices both for the reference object and the evaluated object ranking. Another application is the self-ranking method where a user enters on a web page his/her own parameter ranking in order to find his/her match among a community of users that are subscribed to the same web service.

As one can see ranking an object is not only subject to the voter's opinion but also vary per the current ranking profile. Thus a person can evaluate himself according to one profile and get higher ranks than if he had evaluated himself based on another profile. Although some ranking profiles may pose the self evaluating user in an advantageous ranking, it becomes obvious to that community of users that some ranking profiles are more difficult than others in getting higher ranks just because they define the population distribution in a more biased way.

This evaluation and matching method can take place instead of on a basis of 4 parameters, 4 profiles, 4 ranks, and 4 levels of matching, on a basis of 3 or 5 or more elements in each category.

While this invention is primarily discussed as a method, a person of ordinary skill in the art understands that the apparatus discussed above with reference to a wireless communications system may be programmed to enable the practice of the method of the invention. Moreover, an article of manufacture for use with a wireless communications system, such as a pre-recorded storage device or other similar computer readable medium including program instructions recorded thereon may direct the communications system to facilitate the practice of the method of the invention. It is understood that such apparatus and articles of manufacture also come within the scope of the invention.

The embodiments of the invention described above are intended to be exemplary only. The scope of the invention is therefore intended to be limited solely by the scope of the appended claims.

1. A method for wireless communication between a controller and a group of user devices, each user device having a respective identification number (RFID), comprising:
assigning a sequence number (PID) to each user device;
transmitting the PID from the controller to each user device; and,
in response to a message broadcast from the controller to the group of user devices, receiving a response from each user device in sequence, wherein each response includes the respective PID of the user device, and wherein each user device determines when to transmit its response by comparing its PID with the PID of each transmitted response.

2. The method of claim 1 and further comprising receiving an acknowledgment from each user device indicating that the user device is available, the acknowledgment including the PID of the user device.

3. The method of claim 1 wherein each response includes the RFID of the user device.

4. The method of claim 1 wherein each response is separated by a predetermined period of time.

5. The method of claim 4 wherein each user device determines when to transmit its response from its PID and the predetermined period of time.

6. The method of claim 1 and further comprising registering the RFID of each user device with the controller.

7. The method of claim 1 and further comprising distributing the user devices in an essentially linear arrangement in accordance with the PID of each user device.

8. The method of claim 7 and further comprising relaying each response between user devices having sequential PIDs to extend wireless communication range.

9. The method of claim 1 wherein the group of user devices includes a plurality of groups of user devices.

10. The method of claim 9 and further comprising assigning a sequential group ID (GID) to each of the groups and its respective user devices.

11. The method of claim 10 and further comprising distributing the groups and their respective user devices in an essentially linear arrangement in accordance with the GID and PID of each group and user device, respectively.

12. The method of claim 11 and further comprising relaying each response between user devices having sequential GIDs and PIDs, respectively, to extend wireless communication range.

13. The method of claim 11 wherein each group has a midstream device for communicating directly with the controller.

14. The method of claim 13 and further comprising relaying each response between user devices having sequential PIDs to the midstream device and then to the controller to extend wireless communication range.

15. The method of claim 1 wherein the message is an invitation to vote and the response is a vote.

16. The method of claim 1 wherein the message is a request for alarm status and the response is an alarm.

17. The method of claim 1 wherein the message is a control command the response is a control execution indication.

18. The method of claim 1 wherein each user device is a handheld device having one or more user selectable buttons for generating the response.

19. The method of claim 1 and further comprising authenticating each user device with at least one of the RFID and PID.

20. The method of claim 1 wherein the message is a counting command and the response is a count.

21. The method of claim 1 wherein the controller and user devices are located in a classroom.

22. The method of claim 1 wherein the controller and user devices are located in a vehicle including a bus.

23. The method of claim 7 wherein the linear arrangement is used to conduct a search for one or more missing user devices.

24. The method of claim 7 wherein the linear arrangement is used to conduct a test for radio frequency signal strength for one or more user devices.

25. The method of claim 14 wherein the linear arrangement and the midstream device are a plurality of linear arrangements and midstream devices, respectively.

26. The method of claim 18 wherein the handheld device has a manual scroll selector including a thumbsync selector.

27. The method of claim 26 wherein the selector is for selecting between at least one of wireless modes of operation, communication protocols, and radio frequencies.

28. The method of claim 18 wherein the handheld device has a motion detector.

29. The method of claim 18 wherein the handheld device is a remote control.

30. The method of claim 18 wherein the handheld device is wireless mouse.

31. The method of claim 1 and further comprising transmitting commands from the controller to program the function of each wireless device.

32. The method of claim 31 wherein the controller has an interface to a network, including the Internet, and wherein the commands for programming the function of each wireless device are received over the network.

33. A system for wireless communication with a group of user devices, each user device having a respective identification number (RFID), comprising:
a processor coupled to memory and to a wireless network interface and adapted for:
assigning a sequence number (PID) to each user device;
transmitting the PID from the system to each user device; and,
in response to a message broadcast from the system to the group of user devices, receiving a response from each user device in sequence, wherein each response includes the respective PID of the user device, and wherein each user device determines when to transmit its response by comparing its PID with the PID of each transmitted response.

34. A computer program product having a computer readable medium tangibly embodying computer executable code for directing a controller to communicate wirelessly with a group of user devices, each user device having a respective identification number (RFID), the computer program product comprising:
code for assigning a sequence number (PID) to each user device;
code for transmitting the PID from the controller to each user device; and,
code for, in response to a message broadcast from the controller to the group of user devices, receiving a response from each user device in sequence, wherein each response includes the respective PID of the user device, and wherein each user device determines when to transmit its response by comparing its PID with the PID of each transmitted response.

35. A method for comparing a sample item to a reference item comprising:
selecting parameters for comparing the sample and reference items, the reference item having a predetermined rank score for each of the parameters;
selecting a distribution for tabulating votes received for each of the parameters for the sample item;
displaying the sample item, reference item, and parameters on a display screen, the display screen coupled to a controller in wireless communication with a group of user devices, each user device having a plurality of selection buttons for generating the votes for each of the parameters for the sample item;
receiving the votes at the controller and determining a rank score for each of the parameters for the sample item in accordance with the distribution; and,
displaying at least one indication of whether the rank scores for the sample and reference items match.
